(19) United States
(12) Patent Application Publication
(10) Pub. No.: US 2024/0100452 A1
(43) Pub. Date: Mar. 28, 2024

(54) FILTRATION TESTING DEVICES

(71) Applicant: HERO SCIENTIFIC LTD., Jerusalem (IL)

(72) Inventors: Robert Eric LEVITZ, Beit Shemesh (IL); Zvi FELDMAN, Sde Zvi (IL); Boaz ARIELI, Mevaseret Zion (IL)

(73) Assignee: HERO SCIENTIFIC LTD., Jerusalem (IL)

(21) Appl. No.: 18/023,607

(22) PCT Filed: Aug. 24, 2021
(86) PCT No.: PCT/IL2021/051035

§ 371 Date: Feb. 27, 2023

Related U.S. Application Data
(60) Provisional application No. 63/071,529, filed on Aug. 28, 2020.

(51) Int. Cl. B01D 27/08; B01D 27/14; B01D 35/26; B01D 65/10

(52) U.S. Cl. CPC B01D 27/08; B01D 27/146; B01D 35/26; B01D 65/10; B01D 27/108

(57) ABSTRACT

A filter unit (20, 320, 420, 820, 1020) is provided that includes a filtration chamber (30, 330, 430, 830, 1030) and a filter assembly (32, 132, 232, 432, 532, 632, 732, 832, 1032). A filter cartridge (28, 128, 328, 428, 528, 728, 828, 1028) of the filter assembly (32, 132, 232, 432, 532, 632, 732, 832, 1032) includes a support shell (44, 144, 344, 444, 744, 844) and a filter (60, 860) coupled to a support-shell side wall (50, 350, 850) so as to cover support-shell side openings (52, 352, 852). A handle (62, 162, 262, 362, 662, 762, 862, 1062) of the filter assembly (32, 132, 232, 432, 532, 632, 732, 832, 1032) is coupled to a proximal end of the support shell (44, 144, 344, 444, 744, 844). The filter assembly (32, 132, 232, 432, 532, 632, 732, 832, 1032) is partially insertable into the filtration chamber (30, 330, 430, 830, 1030), such that the filter assembly (32, 132, 232, 432, 532, 632, 732, 832, 1032) passes through a filter-assembly opening (40, 840) of the filtration chamber (30, 330, 430, 830, 1030); the handle (62, 162, 262, 362, 662, 762, 862, 1062) is disposed outside the filtration chamber (30, 330, 430, 830, 1030); and the filter cartridge (28, 128, 328, 428, 528, 728, 828, 1028) is disposed within the filtration chamber (30, 330, 430, 830, 1030). The filter (60, 860) is configured to filter biological particulate from a liquid specimen sample (22) when the liquid specimen sample (22) is driven along a fluid flow path (68, 868) while the filter cartridge (28, 128, 328, 428, 528, 728, 828, 1028) is disposed within the filtration chamber (30, 330, 430, 830, 1030). Other embodiments are also described.

### CROSS-REFERENCE TO RELATED APPLICATIONS

The present application claims priority from U.S. Provisional Application 63/071,529, filed Aug. 28, 2020, which is assigned to the assignee of the present application and incorporated herein by reference.

### FIELD OF THE APPLICATION

Applications of the present invention relate to testing for the presence of particulates, such as bacteria and viruses, in fluids.

### BACKGROUND OF THE APPLICATION

Many techniques exist for testing for the presence of bacteria and viruses for aiding in disease diagnosis. For example, testing for the Influenza virus includes molecular-based detection methods, viral culture methods, and immunoassay methods. Influenza virus testing includes the testing of nasal swabs, nasopharyngeal swabs, nasal aspirates, nasopharyngeal aspirates, nasal washes, nasopharyngeal washes, throat swabs, and a combination of samples.

PCT Publication WO 2018/158768 to Fruchter et al. describes inter alia a method for testing for presence of a particulate selected from the group consisting of: a microorganism, a fungus, a bacteria, a spore, a virus, a mite, a biological cell, a biological antigen, a protein, a protein antigen, and a carbohydrate antigen. The method includes (a) collecting, in a tube, fluid that potentially contains the particulate, (b) using a plunger to push the fluid through a filter disposed at a distal portion of the tube or at a distal end of the plunger, and subsequently, (c) while the filter is inside the tube, ascertaining if any of the particulate was trapped by the filter by applying a particulate-presence-testing-facilitation solution to the filter.

PCT Publication WO 2020/049569 to Fruchter et al. describes inter alia a testing device for testing for the presence of particulate in a liquid. The testing device includes a liquid container for containing the liquid; a filter, disposed in or downstream of the liquid container; a liquid-pressure source, which is arranged to apply pressure to drive the liquid contained in the liquid container through the filter; and a filtration chamber that is (a) disposed downstream of the liquid container, (b) shaped so as to define an inlet, and (c) in fluid communication with the filter.

US Patent Application Publication 2011/0318814 to Kshirsagar et al. describes inter alia a method for isolating microorganisms from a sample, the sample including sample matrix and microorganisms, the method including the steps of providing a receptacle, the receptacle configured to allow filtering of the sample and to reversibly contain the sample and a concentration agent; adding the sample to the receptacle, wherein a microorganism-bound composition will be formed in the receptacle, the microorganism-bound composition including concentration agent-bound microorganisms and sample matrix; and filtering the microorganism-bound composition through a filter to collect the concentration agent-bound microorganisms on the filter. The filter has an average pore size that is greater than the average size of the microorganisms. Kits and systems are also described.

### SUMMARY OF THE APPLICATION

Some embodiments of the present invention provide a filter unit for filtering a liquid specimen sample. The filter unit comprises a filtration chamber and a filter assembly that is configurated to be partially inserted in the filtration chamber, and typically is entirely removable from the filtration chamber using a handle of the filter assembly. The filter assembly comprises a filter cartridge, which comprises a support shell and a filter, both of which may be tubular. The support shell has a support-shell side wall that is shaped so as to define one or more support-shell side openings therethrough to an internal space defined by the filter cartridge. The filter is coupled to the support-shell side wall so as to cover the one or more support-shell side openings.

The filter is configured to filter biological particulate from the liquid specimen sample when the liquid specimen sample is driven along a fluid flow path while the filter cartridge is disposed within the filtration chamber. Afterwards, the filter assembly is entirely removed from the filtration chamber using the handle.

This filter cartridge generally saves time and effort while reducing complications and contamination risk. The shape of the filter cartridge allows easy removal from the filtration chamber, while preventing direct handling of the filter by hand or with forceps, which might lead to contamination of surfaces by the filter, or contamination of the filter itself. In addition, the filter cartridge can be easily removed from the filtration chamber without damaging the filter, which may be fragile, depending on the type of filter. The shape of the filter cartridge also allows easy insertion of the filter into a receptacle for immersion in a liquid medium for transport of the filter. Without the filter cartridge, a filter might need to be folded and/or bunched up, such as using forceps, which is inconvenient and may cause contamination of surfaces by the filter, or contamination of the filter itself during handling.

For some applications, the filter assembly has the general shape and size of a conventional swab, with the handle and the filter cartridge corresponding to the applicator stick and absorbing swab material, respectively. Thus, the filter assembly can be handled and processed using conventional analysis techniques and equipment that are widely available, optionally with minimal or no modifications to conventional processing procedures.

For some applications, after the filter assembly has been entirely removed from the filtration chamber, the filter assembly is transported while the filter is at least partially immersed in a liquid medium contained in a receptacle. For example, the liquid medium may comprise a transport medium, a culture medium, a purification agent, a stabilizing agent, a lysing buffer, or an extraction agent.

In some applications of the present invention, the filter assembly further comprises an occluder, which is configured to selectively occlude at least 50% of a volume of the internal space of the filter cartridge, such as at least 95% of the volume of the internal space of the filter cartridge. The occluder may serve to reduce (optionally entirely) the amount of the liquid medium that flows into the internal space of the filter cartridge when the filter cartridge is within the above-mentioned receptacle. This reduction reduces the volume of the liquid medium necessary for transport of the filter, which reduces the dilution of any biological particulate trapped by the filter, thereby increasing the sensitivity of the subsequent testing for the biological particulate.

Typically, after the filter assembly has been entirely removed from the filtration chamber, and, optionally, the filter cartridge has been transported to a testing laboratory, testing for the presence of the biological particulate trapped by the filter is performed. For example, at least a portion of the liquid medium may be inserted into a testing machine, either with or without filter cartridge. For example, the testing machine may be a nucleic acid amplification instrument for qualitative and/or quantitative detection of a particulate, such as thermal cycler (also known as a PCR machine) or an isothermal amplification instrument. For some applications, the testing machine is a spectrometer instrument for qualitative and/or quantitative detection of a particulate.

In some applications of the present invention, an inner surface of a side wall of the receptacle is shaped so as to define one or more protrusions, which are configured to physically disturb the filter, when the filter assembly is as least partially within the receptacle, so as to help release, from the filter, biological particulate trapped by the filter, such as by cutting, tearing, macerating, scraping, and/or agitating the filter. This improved release of the biological particulate may provide higher sensitivity in the subsequent testing for the biological particulate. For example, the one or more protrusions may be shaped to physically disturb the filter as the filter assembly is advanced into the receptacle, moved forward and backward within the receptacle, and/or rotated within the receptacle. For example, the one or more protrusions may be shaped as one or more ridges, bristles, bumps, spikes, and/or a combination of two or more of these shapes.

For applications in which the receptacle contains a liquid medium, the one or more protrusions are shaped so as to physically disturb the filter while still allowing contact of the liquid medium with the filter, such that the released biological particulate is released into the liquid medium for subsequent testing.

There is therefore provided, in accordance with an Inventive Concept 1 of the present invention, a filter unit for filtering a liquid specimen sample, the filter unit including:
a filtration chamber, which includes a filtration-chamber wall that is shaped so as to define a filtration-chamber inlet, a filtration-chamber outlet, and a filter-assembly opening; and
a filter assembly, which includes:
   (a) a filter cartridge, which includes:
      (i) a support shell, which has proximal and distal ends, and a support-shell side wall that is shaped so as to define one or more support-shell side openings therethrough to an internal space defined by the filter cartridge; and
      (ii) a filter, which is coupled to the support-shell side wall so as to cover the one or more support-shell side openings; and
   (b) a handle, which is coupled to the proximal end of the support shell,
wherein the filter assembly is partially insertable into the filtration chamber, such that (a) the filter assembly passes through and forms a fluid-tight seal with the filter-assembly opening of the filtration chamber, (b) the handle is disposed outside the filtration chamber, and (c) the filter cartridge is disposed within the filtration chamber such that the filter unit defines:
   a filtration-chamber space within the filtration chamber between an inner surface of the filtration-chamber wall and the filter cartridge, and
   a fluid flow path from the filtration-chamber inlet to the filtration-chamber outlet, the fluid flow path providing fluid communication among the filtration-chamber space, the one or more support-shell side openings, and the filter,
wherein the filter is configured to filter biological particulate from the liquid specimen sample when the liquid specimen sample is driven along the fluid flow path while the filter cartridge is disposed within the filtration chamber, and
wherein the filter assembly is entirely removable from the filtration chamber using the handle.
Inventive Concept 2. The filter unit according to Inventive Concept 1, wherein the filter is configured to mechanically filter the biological particulate from the liquid specimen sample by size-based filtration when the liquid specimen sample is driven along the fluid flow path while the filter cartridge is disposed within the filtration chamber.
Inventive Concept 3. The filter unit according to Inventive Concept 1, wherein the filter unit is configured such that when the filter cartridge is disposed within the filtration chamber, the filtration-chamber space entirely surrounds the support-shell side wall.
Inventive Concept 4. The filter unit according to Inventive Concept 1, wherein the filter entirely surrounds the support-shell side wall.
Inventive Concept 5. The filter unit according to Inventive Concept 1, wherein the filter is tubular.
Inventive Concept 6. The filter unit according to Inventive Concept 1, wherein the support shell is tubular.
Inventive Concept 7. The filter unit according to Inventive Concept 6, wherein the support shell is circularly cylindrical.
Inventive Concept 8. The filter unit according to Inventive Concept 6, wherein the support shell is elliptically cylindrical.
Inventive Concept 9. The filter unit according to Inventive Concept 6, wherein the support shell is rectangular.
Inventive Concept 10. The filter unit according to Inventive Concept 1, wherein the filter has an average thickness of between 20 microns and 2 mm.
Inventive Concept 11. The filter unit according to Inventive Concept 1, wherein the filter has a surface area of between 5 and 20 cm2.
Inventive Concept 12. The filter unit according to Inventive Concept 1, further including a motor that is configured to agitate the filter cartridge when the filter cartridge is disposed within the filtration chamber.
Inventive Concept 13. The filter unit according to any one of Inventive Concepts 1-12, wherein the filter-assembly opening passes through a proximal end of the filtration-chamber wall, and wherein the filtration-chamber outlet passes through a distal end of the filtration-chamber wall.
Inventive Concept 14. The filter unit according to Inventive Concept 13, wherein the filtration-chamber inlet passes through a side portion of the filtration-chamber wall.
Inventive Concept 15. The filter unit according to any one of Inventive Concepts 1-12, wherein the filter is coupled to an external surface of the support-shell side wall so as to cover the one or more support-shell side openings.
Inventive Concept 16. The filter unit according to Inventive Concept 15, wherein the filter unit is configured such that when the filter cartridge is disposed within the filtration chamber, the fluid flow path provides the fluid communication in the following sequence: from the filtration-chamber inlet, to the filtration-chamber space, through the filter, through the one or more support-shell side openings to the internal space of the filter cartridge, and to the filtration-chamber outlet.
Inventive Concept 17. The filter unit according to Inventive Concept 16, wherein the filter unit is configured such that when the filter cartridge is disposed within the filtration chamber, the fluid flow path provides the fluid communication in the following sequence: from the filtration-chamber inlet, to the filtration-chamber space, through the filter, through the one or more support-shell side openings to the internal space of the filter cartridge, through the distal end of the support shell, and to the filtration-chamber outlet.
Inventive Concept 18. A liquid-specimen-sample processing system including the filter unit according to Inventive Concept 15, the liquid-specimen-sample processing system further including a receptacle, wherein the filter assembly and the receptacle are configured such that the filter assembly is partially insertable into the receptacle using the handle, such that at least a portion of the handle is outside the receptacle and at least a portion of the filter cartridge is disposed within the receptacle.
Inventive Concept 19. The liquid-specimen-sample processing system according to Inventive Concept 18, wherein an inner surface of a side wall of the receptacle is shaped so as to define one or more protrusions, which are configured to physically disturb the filter, when the filter assembly is as least partially within the receptacle, so as to help release, from the filter, the biological particulate trapped by the filter.
Inventive Concept 20. The liquid-specimen-sample processing system according to Inventive Concept 19, wherein the one or more protrusions are configured to cut, tear, or macerate the filter.
Inventive Concept 21. The liquid-specimen-sample processing system according to Inventive Concept 19, wherein the one or more protrusions are configured to scrape the filter.
Inventive Concept 22. The liquid-specimen-sample processing system according to Inventive Concept 19, wherein the one or more protrusions are configured to agitate the filter.
Inventive Concept 23. The liquid-specimen-sample processing system according to Inventive Concept 19, wherein the receptacle contains a liquid medium, and wherein the one or more protrusions are configured to physically disturb the filter, while still allowing contact of the liquid medium with the filter, such that the released biological particulate is released into the liquid medium for subsequent testing.
Inventive Concept 24. The liquid-specimen-sample processing system according to Inventive Concept 19, wherein the one or more protrusions are configured to physically disturb the filter upon rotation of the filter assembly while within the receptacle. Inventive Concept 25. The liquid-specimen-sample processing system according to Inventive Concept 19, wherein the one or more protrusions are shaped as one or more of the shapes selected from the group consisting of: one or more ridges, bristles, spikes, and bumps.
Inventive Concept 26. The filter unit according to any one of Inventive Concepts 1-12, wherein the filter is coupled to an internal surface of the support-shell side wall so as to cover the one or more support-shell side openings.
Inventive Concept 27. The filter unit according to Inventive Concept 26, wherein the filter unit is configured such that when the filter cartridge is disposed within the filtration chamber, the fluid flow path provides the fluid communication in the following sequence: from the filtration-chamber inlet, to the internal space of the filter cartridge, through the filter, through the one or more support-shell openings, to the filtration-chamber space, and to the filtration-chamber outlet.
Inventive Concept 28. The filter unit according to Inventive Concept 26, wherein the filter assembly further includes an occluder, which is configured to selectively occlude at least 50% of a volume of the internal space of the filter cartridge.
Inventive Concept 29. The filter unit according to Inventive Concept 26, wherein the filtration chamber includes a volume-reduction shaft, which is configured to fill at least 50% of a volume of the internal space of the filter cartridge when the filter cartridge is disposed within the filtration chamber.
Inventive Concept 30. The filter unit according to Inventive Concept 29, wherein the filter assembly further includes an occluder, which is configured to selectively occlude between 50% and 99% of a volume of the internal space of the filter cartridge.
Inventive Concept 31. The filter unit according to any one of Inventive Concepts 1-12, wherein the filter assembly further includes an occluder, which is configured to selectively occlude at least 50% of a volume of the internal space of the filter cartridge.
Inventive Concept 32. The filter unit according to Inventive Concept 31, wherein the occluder is configured to selectively occlude at least 80% of the volume of the internal space of the filter cartridge.
Inventive Concept 33. The filter unit according to Inventive Concept 32, wherein the occluder is configured to selectively occlude at least 90% of the volume of the internal space of the filter cartridge.
Inventive Concept 34. The filter unit according to Inventive Concept 31, wherein the occluder is configured to selectively occlude at least 50% of a volume of the internal space by selectively occupying at least 50% of the volume of the internal space.
Inventive Concept 35. The filter unit according to Inventive Concept 31, wherein the occluder is integrated into the filter assembly, and is configured to selectively assume (a) a non-occluding configuration, in which the occluder does not occlude at least 50% of the volume of the internal space, and (b) an occluding configuration, in which the occluder occludes at least 50% of the volume of the internal space.
Inventive Concept 36. The filter unit according to Inventive Concept 35, wherein the handle is coupled to the occluder, such that movement of the handle with respect to the support shell transitions the occluder from the non-occluding configuration to the occluding configuration.
Inventive Concept 37. The filter unit according to Inventive Concept 31, wherein the occluder includes a tubular shaft, which is configured to be disposable:
   at least partially outside the internal space of the filter cartridge when in a non-occluding configuration, in which the tubular shaft does not occlude at least 50% of the volume of the internal space, and
   at least partially within the internal space of the filter cartridge when in an occluding configuration, in which the tubular shaft occludes at least 50% of the volume of the internal space.
Inventive Concept 38. The filter unit according to Inventive Concept 37, wherein the tubular shaft is slidable with respect to the internal space of the filter cartridge.
Inventive Concept 39. The filter unit according to Inventive Concept 37, wherein the tubular shaft is moveable with respect to a radially-outer portion of the handle and the internal space of the filter cartridge, and wherein the tubular shaft:
   when in the non-occluding configuration, is disposed at least partially within the radially-outer portion of the handle outside the internal space of the filter cartridge, and
   when in the occluding configuration, is disposed at least partially outside the radially-outer portion of the handle within the internal space of the filter cartridge.
Inventive Concept 40. The filter unit according to Inventive Concept 37, wherein a portion of the handle is shaped so as to define the tubular shaft.
Inventive Concept 41. The filter unit according to Inventive Concept 37, wherein the tubular shaft is coupled to a distal end of the handle.
Inventive Concept 42. The filter unit according to Inventive Concept 35,
   wherein the occluder includes an occluder shell, which has proximal and distal ends, and an occluder-shell side wall that is shaped so as to define one or more occluder-shell side openings therethrough to an internal space defined by the occluder shell,
   wherein the occluder shell is disposed within the support shell, and rotatable with respect to the support shell to set an alignment of the one or more occluder-shell side openings with the one or more support-shell side openings, and
   wherein the occluder is configured to selectively assume:
      the non-occluding configuration when the one or more occluder-shell side openings are aligned with the one or more support-shell side openings, and
      the occluding configuration when the one or more occluder-shell side openings are not aligned with the one or more support-shell side openings.
Inventive Concept 43. The filter unit according to Inventive Concept 42, wherein the handle is coupled to the occluder shell, such that rotation of the handle with respect to the support shell rotates the occluder shell with respect to the support shell.
Inventive Concept 44. The filter unit according to Inventive Concept 42,
   wherein the distal end of the support shell is shaped so as to define a support-shell distal outlet, which, when open, is in fluid communication with the filtration-chamber outlet when the filter cartridge is disposed within the filtration chamber, and
   wherein the filter assembly is configured such that:
      when the occluder is in the non-occluding configuration, the support-shell distal outlet is open, and
      when the occluder is in the occluding configuration, the support-shell distal outlet is blocked and thus closed.
Inventive Concept 45. The filter unit according to Inventive Concept 44,
   wherein the support shell is shaped so as to further define, at the distal end thereof, and a support-shell distal wall that is shaped so as to define one or more support-shell distal openings therethrough to the internal space defined by the filter cartridge,
   wherein the oceluder shell is shaped so as to further to define, at the distal end thereof, an oceluder-shell distal wall that is shaped so as to define one or more oceluder-shell distal openings therethrough to the internal space defined by the oceluder shell,
   wherein the oceluder shell is rotatable with respect to the support shell to set the alignment of the one or more occluder-shell side openings with the one or more support-shell side openings, and an alignment of the one or more occluder-shell distal openings with the one or more support-shell distal openings,
   wherein the occluder is configured to selectively assume:
      the non-occluding configuration when the one or more occluder-shell side openings are aligned with the one or more support-shell side openings, and the one or more occluder-shell distal openings are aligned with the one or more support-shell distal openings, and
      the occluding configuration when the one or more occluder-shell side openings are not aligned with the one or more support-shell side openings, and the one or more occluder-shell distal openings are not aligned with the one or more support-shell distal openings.
Inventive Concept 46. The filter unit according to Inventive Concept 44, wherein the occluder further includes a pressure-activated valve in fluid communication with the distal end of the support shell.
Inventive Concept 47. The filter unit according to Inventive Concept 31, wherein the filter is coupled to an external surface of the support-shell side wall so as to cover the one or more support-shell side openings.
Inventive Concept 48. The filter unit according to Inventive Concept 31, wherein the filter is coupled to an internal surface of the support-shell side wall so as to cover the one or more support-shell side openings.
Inventive Concept 49. The filter unit according to any one of Inventive Concepts 1-12, wherein the filter assembly further includes an occluder, which is configured to permanently occlude at least 50% and no more than 99% of a volume of the internal space of the filter cartridge.
Inventive Concept 50. The filter unit according to Inventive Concept 49, wherein the occluder is coupled to a distal surface of the handle.
Inventive Concept 51. The filter unit according to Inventive Concept 49, wherein the filter is coupled to an external surface of the support-shell side wall so as to cover the one or more support-shell side openings.
Inventive Concept 52. A liquid-specimen-sample processing system including the filter unit according to any one of Inventive Concepts 1-12, the liquid-specimen-sample processing system further including a fluid-pressure source, which is arranged to apply pressure to drive the liquid specimen sample along the fluid flow path.
Inventive Concept 53. The liquid-specimen-sample processing system according to Inventive Concept 52, wherein the fluid-pressure source is configured to pump gas into the filtration-chamber inlet to complete the driving of the liquid specimen sample into the filtration-chamber inlet.
Inventive Concept 54. A liquid-specimen-sample processing system including the filter unit according to any one of Inventive Concepts 1-12, the liquid-specimen-sample processing system further including:
   a receptacle configured to receive the filter cartridge; and
   an occluder, which is configured to selectively occlude at least 50% of a volume of the internal space of the filter cartridge, and which includes a tubular shaft disposed within the receptacle, protruding upward from a floor of the receptacle, and
wherein the tubular shaft is configured to be disposable:
   at least partially outside the internal space of the filter cartridge when in a non-occluding configuration, in which the tubular shaft does not occlude at least 50% of the volume of the internal space, and
   at least partially within the internal space of the filter cartridge when in an occluding configuration, in which the tubular shaft occludes at least 50% of the volume of the internal space.
Inventive Concept 55. A liquid-specimen-sample processing system including the filter unit according to any one of Inventive Concepts 1-12,
   wherein the filter unit is a first filter unit, the filtration chamber is a first filtration chamber, the filtration-chamber wall is a first filtration-chamber wall, the filtration-chamber inlet is a first filtration-chamber inlet, the filtration-chamber outlet is a first filtration-chamber outlet, the filter-assembly opening is a first filter-assembly opening, the filter assembly is a first filter assembly, the filter cartridge is a first filter cartridge, the support shell is a first support shell, the support-shell side wall is a first-support-shell side wall, the filter is a first filter, the handle is a first handle, and the fluid flow path is a first fluid flow path,
   wherein the liquid-specimen-sample processing system further includes a second filter unit, which includes:
      a second filtration chamber, which includes a second filtration-chamber wall that is shaped so as to define a second filtration-chamber inlet, a second filtration-chamber outlet, and a second filter-assembly opening; and
      a second filter assembly, which includes:
         (a) a second filter cartridge, which includes:
         (i) a second support shell, which has proximal and distal ends, and a second-support-shell side wall that is shaped so as to define one or more second-support-shell side openings therethrough to an internal space defined by the second support shell; and
         (ii) a second filter, which is coupled to the second-support-shell side wall so as to cover the one or more second-support-shell side openings; and
         (b) a second handle, which is coupled to the proximal end of the second support shell,
      wherein the second filter assembly is partially insertable into the second filtration chamber, such that (a) the second filter assembly passes through and forms a fluid-tight seal with the second filter-assembly opening of the second filtration chamber, (b) the second handle is disposed outside the second filtration chamber, and (c) the second filter cartridge is disposed within the second filtration chamber such that the second filter unit defines:
         a second filtration-chamber space within the second filtration chamber between an inner surface of the second filtration-chamber wall and the second filter cartridge, and
         a second fluid flow path from the second filtration-chamber inlet to the second filtration-chamber outlet, the second fluid flow path providing fluid communication among the second filtration-chamber space, the one or more second-support-shell side openings, and the second filter,
      wherein the second filter is configured to filter biological particulate from the liquid specimen sample when the liquid specimen sample is driven along the second fluid flow path while the second filter cartridge is disposed within the second filtration chamber, and
      wherein the second filter assembly is entirely removable from the second filtration chamber using the second handle, and
   wherein first filtration-chamber outlet is in fluid communication with the second filtration-chamber inlet.
Inventive Concept 56. The liquid-specimen-sample processing system according to Inventive Concept 55,
   wherein the first filter has a first average absolute pore size, and is configured to mechanically filter the biological particulate from the liquid specimen sample by size-based filtration when the liquid specimen sample is driven along the first fluid flow path while the first filter cartridge is disposed within the first filtration chamber,
   wherein the second filter has a second average absolute pore size, and is configured to mechanically filter the biological particulate from the liquid specimen sample by size-based filtration when the liquid specimen sample is driven along the second fluid flow path while the second filter cartridge is disposed within the second filtration chamber, and
   wherein the second average absolute pore size is less than the first average absolute pore size.
Inventive Concept 57. The liquid-specimen-sample processing system according to Inventive Concept 55,
   wherein the first filter has a first average nominal pore size, and is configured to mechanically filter the biological particulate from the liquid specimen sample by size-based filtration when the liquid specimen sample is driven along the first fluid flow path while the first filter cartridge is disposed within the first filtration chamber,
   wherein the second filter has a second average nominal pore size, and is configured to mechanically filter the biological particulate from the liquid specimen sample by size-based filtration when the liquid specimen sample is driven along the second fluid flow path while the second filter cartridge is disposed within the second filtration chamber, and
   wherein the second average nominal pore size is less than the first average nominal pore size.
Inventive Concept 58. A liquid-specimen-sample processing system including the filter unit according to any one of Inventive Concepts 1-12, the liquid-specimen-sample processing system further including a waste liquid receptacle, which is coupled to filtration chamber in fluid communication with the filtration-chamber outlet.
Inventive Concept 59. The liquid-specimen-sample processing system according to Inventive Concept 58, wherein the waste liquid receptacle is shaped so as to define an opening through an external wall of the waste liquid receptacle, and wherein the waste liquid receptacle includes an air filter that is disposed to filter air that passes out of the waste liquid receptacle through the opening.

There is further provided, in accordance with an Inventive Concept 60 of the present invention, a filter assembly for filtering a liquid specimen sample, the filter assembly including:
a filter cartridge, which includes:
   (a) a support shell, which has proximal and distal ends, and a support-shell side wall that is shaped so as to define one or more support-shell side openings therethrough to an internal space defined by the filter cartridge; and
   (b) a filter, which is coupled to the support-shell side wall so as to cover the one or more support-shell side openings, and which is configured to filter biological particulate from the liquid specimen sample when the liquid specimen sample is driven through the filter and the one or more support-shell side openings; a handle, which is coupled to the proximal end of the support shell; and an occluder, which is configured to selectively occlude at least 50% of a volume of the internal space of the filter cartridge.
Inventive Concept 61. The filter assembly according to Inventive Concept 60, wherein the filter has an average thickness of between 20 microns and 2 mm.
Inventive Concept 62. The filter assembly according to Inventive Concept 60, wherein the filter has a surface area of between 5 and 20 cm2.
Inventive Concept 63. The filter assembly according to Inventive Concept 60, wherein the occluder is configured to selectively occlude at least 80% of the volume of the internal space of the filter cartridge.
Inventive Concept 64. The filter assembly according to Inventive Concept 63, wherein the occluder is configured to selectively occlude at least 90% of the volume of the internal space of the filter cartridge.
Inventive Concept 65. The filter assembly according to Inventive Concept 60, wherein the occluder is configured to selectively occlude at least 50% of a volume of the internal space by selectively occupying at least 50% of the volume of the internal space.
Inventive Concept 66. The filter assembly according to any one of Inventive Concepts 60-65, wherein the filter is coupled to an internal surface of the support-shell side wall so as to cover the one or more support-shell side openings.
Inventive Concept 67. The filter assembly according to any one of Inventive Concepts 60-65, wherein the filter is coupled to an external surface of the support-shell side wall so as to cover the one or more support-shell side openings.
Inventive Concept 68. A liquid-specimen-sample processing system including the filter assembly according to Inventive Concept 67, the liquid-specimen-sample processing system further including a receptacle, wherein the filter assembly and the receptacle are configured such that the filter assembly is partially insertable into the receptacle using the handle, such that at least a portion of the handle is outside the receptacle and at least a portion of the filter cartridge is disposed within the receptacle.
Inventive Concept 69. The liquid-specimen-sample processing system according to Inventive Concept 68, wherein an inner surface of a side wall of the receptacle is shaped so as to define one or more protrusions, which are configured to physically disturb the filter, when the filter assembly is as least partially within the receptacle, so as to help release, from the filter, the biological particulate trapped by the filter.
Inventive Concept 70. The liquid-specimen-sample processing system according to Inventive Concept 69, wherein the one or more protrusions are configured to cut, tear, or macerate the filter.
Inventive Concept 71. The liquid-specimen-sample processing system according to Inventive Concept 69, wherein the one or more protrusions are configured to scrape the filter.
Inventive Concept 72. The liquid-specimen-sample processing system according to Inventive Concept 69, wherein the one or more protrusions are configured to agitate the filter.
Inventive Concept 73. The liquid-specimen-sample processing system according to Inventive Concept 69, wherein the receptacle contains a liquid medium, and wherein the one or more protrusions are configured to physically disturb the filter, while still allowing contact of the liquid medium with the filter, such that the released biological particulate is released into the liquid medium for subsequent testing.
Inventive Concept 74. The liquid-specimen-sample processing system according to Inventive Concept 69, wherein the one or more protrusions are configured to physically disturb the filter upon rotation of the filter assembly while within the receptacle.
Inventive Concept 75. The liquid-specimen-sample processing system according to Inventive Concept 69, wherein the one or more protrusions are shaped as one or more of the shapes selected from the group consisting of: one or more ridges, bristles, spikes, and bumps.
Inventive Concept 76. The filter assembly according to any one of Inventive Concepts 60-65, wherein the occluder is integrated into the filter assembly, and is configured to selectively assume (a) a non-occluding configuration, in which the occluder does not occlude at least 50% of the volume of the internal space, and (b) an occluding configuration, in which the occluder occludes at least 50% of the volume of the internal space.
Inventive Concept 77. The filter assembly according to Inventive Concept 76, wherein the handle is coupled to the occluder, such that movement of the handle with respect to the support shell transitions the occluder from the non-occluding configuration to the occluding configuration.
Inventive Concept 78. The filter assembly according to any one of Inventive Concepts 60-652, wherein the occluder includes a tubular shaft, which is configured to be disposable:
   at least partially outside the internal space of the filter cartridge when in a non-occluding configuration, in which the tubular shaft does not occlude at least 50% of the volume of the internal space, and
   at least partially within the internal space of the filter cartridge when in an occluding configuration, in which the tubular shaft occludes at least 50% of the volume of the internal space.
Inventive Concept 79. The filter assembly according to Inventive Concept 78, wherein the tubular shaft is slidable with respect to the internal space of the filter cartridge.
Inventive Concept 80. The filter assembly according to Inventive Concept 78, wherein the tubular shaft is moveable with respect to a radially-outer portion of the handle and the internal space of the filter cartridge, and wherein the tubular shaft:
   when in the non-occluding configuration, is disposed at least partially within the radially-outer portion of the handle outside the internal space of the filter cartridge, and
   when in the occluding configuration, is disposed at least partially outside the radially-outer portion of the handle within the internal space of the filter cartridge.
Inventive Concept 81. The filter assembly according to Inventive Concept 78, wherein a portion of the handle is shaped so as to define the tubular shaft.
Inventive Concept 82. The filter assembly according to Inventive Concept 78, wherein the tubular shaft is coupled to a distal end of the handle.
Inventive Concept 83. The filter assembly according to Inventive Concept 76,
   wherein the occluder includes an occluder shell, which has proximal and distal ends, and an occluder-shell side wall that is shaped so as to define one or more occluder-shell side openings therethrough to an internal space defined by the occluder shell,
   wherein the occluder shell is disposed within the support shell, and rotatable with respect to the support shell to set an alignment of the one or more occluder-shell side openings with the one or more support-shell side openings, and
   wherein the occluder is configured to selectively assume:
      the non-occluding configuration when the one or more occluder-shell side openings are aligned with the one or more support-shell side openings, and
      the occluding configuration when the one or more occluder-shell side openings are not aligned with the one or more support-shell side openings.
Inventive Concept 84. The filter assembly according to Inventive Concept 83, wherein the handle is coupled to the occluder shell, such that rotation of the handle with respect to the support shell rotates the occluder shell with respect to the support shell.
Inventive Concept 85. The filter assembly according to Inventive Concept 83,
   wherein the distal end of the support shell is shaped so as to define a support-shell distal outlet, and
   wherein the filter assembly is configured such that:
      when the occluder is in the non-occluding configuration, the support-shell distal outlet is open, and
      when the occluder is in the occluding configuration, the support-shell distal outlet is blocked and thus closed.
Inventive Concept 86. The filter assembly according to Inventive Concept 85,
   wherein the support shell is shaped so as to further define, at the distal end thereof, and a support-shell distal wall that is shaped so as to define one or more support-shell distal openings therethrough to the internal space defined by the filter cartridge,
   wherein the occluder shell is shaped so as to further to define, at the distal end thereof, an occluder-shell distal wall that is shaped so as to define one or more occluder-shell distal openings therethrough to the internal space defined by the occluder shell,
   wherein the occluder shell is rotatable with respect to the support shell to set the alignment of the one or more occluder-shell side openings with the one or more support-shell side openings, and an alignment of the one or more occluder-shell distal openings with the one or more support-shell distal openings,
   wherein the occluder is configured to selectively assume:
      the non-occluding configuration when the one or more occluder-shell side openings are aligned with the one or more support-shell side openings, and the one or more occluder-shell distal openings are aligned with the one or more support-shell distal openings, and
      the occluding configuration when the one or more occluder-shell side openings are not aligned with the one or more support-shell side openings, and the one or more occluder-shell distal openings are not aligned with the one or more support-shell distal openings.
Inventive Concept 87. The filter assembly according to Inventive Concept 85, wherein the occluder further includes a pressure-activated valve in fluid communication with the distal end of the support shell.

There is still further provided, in accordance with an Inventive Concept 88 of the present invention, a method including:
driving a liquid specimen sample into a filtration-chamber inlet defined by a filtration-chamber wall of a filtration chamber of a filter unit, the filter unit further including a filter assembly, which includes: (a) a filter cartridge, which includes: (i) a support shell, which has proximal and distal ends, and a support-shell side wall that is shaped so as to define one or more support-shell side openings therethrough to an internal space defined by the filter cartridge; and (ii) a filter, which is coupled to the support-shell side wall so as to cover the one or more support-shell side openings; and (b) a handle, which is coupled to the proximal end of the support shell,
   wherein driving includes driving the liquid specimen sample into the filtration-chamber inlet while the filter assembly is partially inserted into the filtration chamber, such that (a) the filter assembly passes through and forms a fluid-tight seal with a filter-assembly opening defined by the filtration-chamber wall, (b) the handle is disposed outside the filtration chamber, and (c) the filter cartridge is disposed within the filtration chamber such that the filter unit defines: (i) a filtration-chamber space within the filtration chamber between an inner surface of the filtration-chamber wall and the filter cartridge, and (ii) a fluid flow path from the filtration-chamber inlet to a filtration-chamber outlet defined by the filtration-chamber wall, the fluid flow path providing fluid communication among the filtration-chamber space, the one or more support-shell side openings, and the filter, wherein the filter is configured to filter biological particulate from the liquid specimen sample when the liquid specimen sample is driven along the fluid flow path while the filter cartridge is disposed within the filtration chamber; and
after finishing driving the liquid specimen sample into the filtration-chamber inlet, entirely removing the filter assembly from the filtration chamber using the handle.
Inventive Concept 89. The method according to Inventive Concept 88, wherein entirely removing the filter assembly from the filtration chamber using the handle includes entirely removing the filter assembly from the filtration chamber using only the handle, without otherwise touching the filter.
Inventive Concept 90. The method according to Inventive Concept 88, further including, after entirely removing the filter assembly from the filtration chamber, testing for the presence of the biological particulate trapped by the filter.
Inventive Concept 91. The method according to Inventive Concept 90, wherein testing for the presence of the biological particulate includes inserting the filter cartridge into a testing machine.
Inventive Concept 92. The method according to Inventive Concept 90, wherein testing for the presence of the biological particulate includes inserting the filter cartridge into a liquid medium.
Inventive Concept 93. The method according to Inventive Concept 92, wherein testing for the presence of the biological particulate includes agitating the filter cartridge in the liquid medium.
Inventive Concept 94. The method according to Inventive Concept 93, wherein agitating the filter cartridge in the liquid medium includes mixing the filter cartridge in the liquid medium.
Inventive Concept 95. The method according to Inventive Concept 92, wherein testing for the presence of the biological particulate includes transferring at least a portion of the liquid medium into a testing machine.
Inventive Concept 96. The method according to Inventive Concept 92, wherein the liquid medium is selected from the group consisting of: a transport medium, a culture medium, a purification agent, a stabilizing agent, a lysing buffer, and an extraction agent.
Inventive Concept 97. The method according to Inventive Concept 91, wherein the testing machine is selected from the group consisting of: a thermal cycler and an isothermal amplification instrument.
Inventive Concept 98. The method according to Inventive Concept 90, further including, after entirely removing the filter assembly from the filtration chamber and before testing for the presence of the biological particulate, transporting the filter assembly while the filter is at least partially immersed in a liquid medium.
Inventive Concept 99. The method according to Inventive Concept 98, wherein testing for the presence of the biological particulate includes inserting at least a portion of the liquid medium into a thermal cycler.
Inventive Concept 100. The method according to Inventive Concept 98, wherein testing for the presence of the biological particulate includes agitating the filter in the liquid medium.
Inventive Concept 101. The method according to Inventive Concept 98, wherein the liquid medium is selected from the group consisting of: a transport medium, a culture medium, a purification agent, a stabilizing agent, a lysing buffer, and an extraction agent.
Inventive Concept 102. The method according to Inventive Concept 90, wherein testing for the presence of the biological particulate includes incubating the filter in a growth medium.
Inventive Concept 103. The method according to Inventive Concept 88, wherein the liquid specimen sample is a non-centrifuged liquid specimen sample, and wherein driving includes driving the non-centrifuged liquid specimen sample into the filtration-chamber inlet.
Inventive Concept 104. The method according to Inventive Concept 88, wherein driving the liquid specimen sample into the filtration-chamber inlet including pumping gas into the filtration-chamber inlet to complete the driving of the liquid specimen sample into the filtration-chamber inlet.
Inventive Concept 105. The method according to Inventive Concept 88, further including agitating the filter cartridge while the filter cartridge is disposed within the filtration chamber.
Inventive Concept 106. The method according to Inventive Concept 88, further including agitating the filter cartridge after entirely removing the filter assembly from the filtration chamber.
Inventive Concept 107. The method according to 106, further including agitating the filter cartridge after the filter assembly has been inserted into a liquid medium.
Inventive Concept 108. The method according to Inventive Concept 88,
   wherein the filter assembly further includes an occluder, which is configured to selectively occlude at least 50% of a volume of the internal space of the filter cartridge,
   wherein driving the liquid specimen sample into the filtration-chamber inlet includes driving the liquid specimen sample into the filtration-chamber inlet while the oceluder is in a non-occluding configuration, in which the occluder does not occlude at least at least 50% of the volume of the internal space, and
   wherein the method further includes, after finishing driving the liquid specimen sample into the filtration-chamber inlet, transitioning the occluder from the non-occluding configuration to an occluding configuration, in which the occluder occludes at least 50% of the volume of the internal space.
Inventive Concept 109. The method according to Inventive Concept 108, wherein transitioning the occluder from the non-occluding configuration to the occluding configuration includes transitioning the occluder from the non-occluding configuration to the occluding configuration before entirely removing the filter assembly from the filtration chamber.
Inventive Concept 110. The method according to Inventive Concept 108, wherein transitioning the occluder from the non-occluding configuration to the occluding configuration includes transitioning the occluder from the non-occluding configuration to the occluding configuration after entirely removing the filter assembly from the filtration chamber.
Inventive Concept 111. The method according to Inventive Concept 108, wherein transitioning the occluder from the non-occluding configuration to the occluding configuration includes transitioning the occluder from the non-occluding configuration to the occluding configuration during removal of the filter assembly from the filtration chamber.
Inventive Concept 112. The method according to Inventive Concept 108, wherein the occluder is configured to selectively occlude at least 80% of the volume of the internal space of the filter cartridge.
Inventive Concept 113. The method according to Inventive Concept 112, wherein the occluder is configured to selectively occlude at least 90% of the volume of the internal space of the filter cartridge.
Inventive Concept 114. The method according to Inventive Concept 108, wherein the occluder is configured to selectively occlude at least 50% of a volume of the internal space by selectively occupying at least 50% of the volume of the internal space.
Inventive Concept 115. The method according to Inventive Concept 108, wherein the occluder is integrated into the filter assembly.
Inventive Concept 116. The method according to Inventive Concept 115, wherein the handle is coupled to the occluder, and wherein transitioning the occluder from the non-occluding configuration to the occluding configuration includes moving the handle with respect to the support shell.
Inventive Concept 117. The method according to Inventive Concept 108, wherein the occluder includes a tubular shaft, which is configured to be disposable:
   at least partially outside the internal space of the filter cartridge when in a non-occluding configuration, in which the tubular shaft does not occlude at least 50% of the volume of the internal space, and
   at least partially within the internal space of the filter cartridge when in an occluding configuration, in which the tubular shaft occludes at least 50% of the volume of the internal space.
Inventive Concept 118. The method according to Inventive Concept 117, wherein transitioning the occluder from the non-occluding configuration to the occluding configuration includes sliding the tubular shaft with respect to the internal space of the filter cartridge.
Inventive Concept 119. The method according to Inventive Concept 115,
   wherein the occluder includes an occluder shell, which has proximal and distal ends, and an occluder-shell side wall that is shaped so as to define one or more occluder-shell side openings therethrough to an internal space defined by the occluder shell,
   wherein the occluder shell is disposed within the support shell, and rotatable with respect to the support shell to set an alignment of the one or more occluder-shell side openings with the one or more support-shell side openings, and
   wherein the occluder is configured to selectively assume:
      the non-occluding configuration when the one or more occluder-shell side openings are aligned with the one or more support-shell side openings, and
      the occluding configuration when the one or more occluder-shell side openings are not aligned with the one or more support-shell side openings.
Inventive Concept 120. The method according to Inventive Concept 119, wherein the handle is coupled to the occluder shell, and wherein transitioning the occluder from the non-occluding configuration to the occluding configuration includes rotating the handle with respect to the support shell so as to rotate the occluder shell with respect to the support shell.
Inventive Concept 121. The method according to Inventive Concept 88,
   wherein the filter unit is a first filter unit, the filtration chamber is a first filtration chamber, the filtration-chamber wall is a first filtration-chamber wall, the filtration-chamber inlet is a first filtration-chamber inlet, the filtration-chamber outlet is a first filtration-chamber outlet, the filter-assembly opening is a first filter-assembly opening, the filter assembly is a first filter assembly, the filter cartridge is a first filter cartridge, the support shell is a first support shell, the filter is a first filter, the handle is a first handle, and the fluid flow path is a first fluid flow path,
   wherein driving the liquid specimen sample into the first filtration-chamber inlet drives the liquid specimen sample out of the first filtration-chamber outlet and into a second filtration-chamber inlet defined by a second filtration-chamber wall of a second filtration chamber of a second filter unit, the second filter unit further including a second filter assembly, which includes: (a) a second filter cartridge, which includes: (i) a second support shell, which has proximal and distal ends, and a second support-shell side wall that is shaped so as to define one or more support-shell side openings therethrough to an internal space defined by the second filter cartridge; and (ii) a second filter, which is coupled to the second support-shell side wall so as to cover the one or more support-shell side openings; and (b) a second handle, which is coupled to the proximal end of the second support shell,
   wherein driving includes driving the liquid specimen sample into the first filtration-chamber inlet while the second filter assembly is partially inserted into the second filtration chamber, such that (a) the second filter assembly passes through and forms a fluid-tight seal with a second filter-assembly opening defined by the second filtration-chamber wall, (b) the second handle is disposed outside the second filtration chamber, and (c) the second filter cartridge is disposed within the second filtration chamber such that the second filter unit defines: (i) a filtration-chamber space within the second filtration chamber between an inner surface of the second filtration-chamber wall and second the filter cartridge, and (ii) a second fluid flow path from the second filtration-chamber inlet to a second filtration-chamber outlet defined by the second filtration-chamber wall, the second fluid flow path providing fluid communication among the filtration-chamber space, the one or more support-shell side openings, and the second filter, wherein the second filter is configured to filter biological particulate from the liquid specimen sample when the liquid specimen sample is driven along the second fluid flow path while the second filter cartridge is disposed within the second filtration chamber; and
   wherein the method further includes, after finishing driving the liquid specimen sample into the first filtration-chamber inlet, entirely removing the second filter assembly from the second filtration chamber using the second handle.
Inventive Concept 122. The method according to Inventive Concept 121, further including, after entirely removing the first and the second filter assemblies from the first and the second filtration chambers, respectively, testing for the presence of the biological particulate trapped by the first and the second filters.
Inventive Concept 123. The method according to Inventive Concept 121,
   wherein the first and the second filters are configured to filter first and second biological particulates from the liquid specimen sample, the first and the second biological particulates of different types, and
   wherein the method further including, after entirely removing the first and the second filter assemblies from the first and the second filtration chambers, respectively, testing for the presence of the first and the second biological particulates trapped by the first and the second filters, respectively.

There is additionally provided, in accordance with an Inventive Concept 124 of the present invention, a method including:
filtering a liquid specimen sample using a filter assembly that includes (a) a filter cartridge, which includes: (i) a support shell, which has proximal and distal ends, and a support-shell side wall that is shaped so as to define one or more support-shell side openings therethrough to an internal space defined by the filter cartridge; and (ii) a filter, which is coupled to the support-shell side wall so as to cover the one or more support-shell side openings, and which is configured to filter biological particulate from the liquid specimen sample when the liquid specimen sample is driven through the filter and the one or more support-shell side openings; (b) a handle, which is coupled to the proximal end of the support shell; and (c) an occluder, which is configured to selectively occlude at least 50% of a volume of the internal space of the filter cartridge,
   wherein filtering the liquid specimen includes driving the liquid specimen sample through the filter and the one or more support-shell side openings while the oceluder is in a non-occluding configuration, in which the occluder does not occlude at least at least 50% of the volume of the internal space; and
after filtering the liquid specimen sample, transitioning the occluder from the non-occluding configuration to an occluding configuration, in which the occluder occludes at least 50% of the volume of the internal space.
Inventive Concept 125. The method according to Inventive Concept 124, wherein the occluder is configured to selectively occlude at least 80% of the volume of the internal space of the filter cartridge.
Inventive Concept 126. The method according to Inventive Concept 125, wherein the occluder is configured to selectively occlude at least 90% of the volume of the internal space of the filter cartridge.

There is yet additionally provided, in accordance with an Inventive Concept 127 of the present invention, a liquid-specimen-sample processing system for processing a liquid specimen sample, the liquid-specimen-sample processing system including:
(a) a filter assembly, which includes:
   (i) a filter cartridge, which includes:
      (A) a support shell, which has proximal and distal ends, and a support-shell side wall that is shaped so as to define one or more support-shell side openings therethrough to an internal space defined by the filter cartridge; and
      (B) a filter, which is coupled to an external surface of the support-shell side wall so as to cover the one or more support-shell side openings, and which is configured to filter biological particulate from the liquid specimen sample when the liquid specimen sample is driven through the filter and the one or more support-shell side openings;
   (ii) a handle, which is coupled to the proximal end of the support shell; and
(b) a receptacle, wherein the filter assembly and the receptacle are configured such that the filter assembly is partially insertable into the receptacle using the handle, such that at least a portion of the handle is outside the receptacle and at least a portion of the filter cartridge is disposed within the receptacle, wherein an inner surface of a side wall of the receptacle is shaped so as to define one or more protrusions, which are configured to physically disturb the filter, when the filter assembly is as least partially within the receptacle, so as to help release, from the filter, the biological particulate trapped by the filter.
Inventive Concept 128. The liquid-specimen-sample processing system according to Inventive Concept 127, wherein the one or more protrusions are configured to cut, tear, or macerate the filter.
Inventive Concept 129. The liquid-specimen-sample processing system according to Inventive Concept 127, wherein the one or more protrusions are configured to scrape the filter.
Inventive Concept 130. The liquid-specimen-sample processing system according to Inventive Concept 127, wherein the one or more protrusions are configured to agitate the filter.
Inventive Concept 131. The liquid-specimen-sample processing system according to any one of Inventive Concepts 127-130, wherein the receptacle contains a liquid medium, and wherein the one or more protrusions are configured to physically disturb the filter, while still allowing contact of the liquid medium with the filter, such that the released biological particulate is released into the liquid medium for subsequent testing.
Inventive Concept 132. The liquid-specimen-sample processing system according to any one of Inventive Concepts 127-130, wherein the one or more protrusions are configured to physically disturb the filter upon rotation of the filter assembly while within the receptacle.
Inventive Concept 133. The liquid-specimen-sample processing system according to any one of Inventive Concepts 127-130, wherein the one or more protrusions are configured to physically disturb the filter during insertion of the filter assembly into the receptacle.
Inventive Concept 134. The liquid-specimen-sample processing system according to any one of Inventive Concepts 127-130, wherein the one or more protrusions are shaped as one or more of the shapes selected from the group consisting of: one or more ridges, bristles, spikes, and bumps.

There is also provided, in accordance with an Inventive Concept 135 of the present invention, a method including
filtering a liquid specimen sample using a filter assembly that includes (a) a filter cartridge, which includes: (i) a support shell, which has proximal and distal ends, and a support-shell side wall that is shaped so as to define one or more support-shell side openings therethrough to an internal space defined by the filter cartridge; and (ii) a filter, which is coupled to an external surface of the support-shell side wall so as to cover the one or more support-shell side openings, and which is configured to filter biological particulate from the liquid specimen sample when the liquid specimen sample is driven through the filter and the one or more support-shell side openings; and (b) a handle, which is coupled to the proximal end of the support shell; and
after filtering the liquid specimen sample, partially inserting the filter assembly into a receptacle using the handle, such that at least a portion of the handle is outside the receptacle and at least a portion of the filter cartridge is disposed within the receptacle, wherein an inner surface of a side wall of the receptacle is shaped so as to define one or more protrusions, which are configured to physically disturb the filter, when the filter assembly is as least partially within the receptacle, so as to help release, from the filter, the biological particulate trapped by the filter.
Inventive Concept 136. The method according to Inventive Concept 135, wherein inserting the filter assembly into the receptacle includes inserting the filter assembly into the receptacle while the receptacle contains a liquid medium, and wherein the one or more protrusions are configured to physically disturb the filter, while still allowing contact of the liquid medium with the filter.
Inventive Concept 137. The method according to Inventive Concept 135, wherein the one or more protrusions are configured to physically disturb the filter upon rotation of the filter assembly while within the receptacle, and wherein the method further includes rotating the filter assembly while within the receptacle.
Inventive Concept 138. The method according to Inventive Concept 135, wherein the one or more protrusions are configured to physically disturb the filter during insertion of the filter assembly into the receptacle, and wherein partially inserting the filter assembly into the receptacle includes physically disturbing the filter while partially inserting the filter assembly into the receptacle.
Inventive Concept 139. The method according to Inventive Concept 135, wherein the one or more protrusions are shaped as one or more of the shapes selected from the group consisting of: one or more ridges, bristles, spikes, and bumps.

The present invention will be understood from the following detailed description of embodiments thereof, taken together with the drawings, in which:

### BRIEF DESCRIPTION OF THE DRAWINGS

FIG. 1 is a schematic illustration of a liquid-specimen-sample processing system, in accordance with an application of the present invention;

FIGS. 2A-C are schematic illustrations of a filter unit of the liquid-specimen-sample processing system of FIG. 1, in accordance with an application of the present invention;

FIGS. 3A-B are schematic illustrations of a filter assembly, in accordance with an application of the present invention;

FIGS. 4A-B are schematic illustrations of another filter assembly, in accordance with an application of the present invention;

FIGS. 5A-C are schematic illustrations of another filter unit, in accordance with an application of the present invention;

FIG. 5D is a schematic illustration of a configuration of a filter assembly of the filter unit of FIGS. 5A-C, in accordance with an application of the present invention;

FIGS. 6A-B which are schematic illustrations of yet another filter unit, in accordance with an application of the present invention;

FIGS. 7A-B are schematic illustrations of a portion of another liquid-specimen-sample processing system, in accordance with an application of the present invention;

FIGS. 8A-C are schematic illustrations of a portion of yet another liquid-specimen-sample processing system, in accordance with an application of the present invention;

FIG. 9 is a schematic illustration of another filter unit, in accordance with an application of the present invention;

FIG. 10 is a schematic illustration of another filter assembly, in accordance with an application of the present invention;

FIGS. 11A-C are schematic illustrations of still another liquid-specimen-sample processing system, in accordance with an application of the present invention;

FIG. 12 is a schematic illustration of a portion of another liquid-specimen-sample processing system, in accordance with an application of the present invention; and

FIGS. 13A-E are schematic illustrations of the partial insertion of a filter assembly of FIGS. 2A-C into a receptacle, in accordance with respective applications of the present invention.

### DETAILED DESCRIPTION OF APPLICATIONS

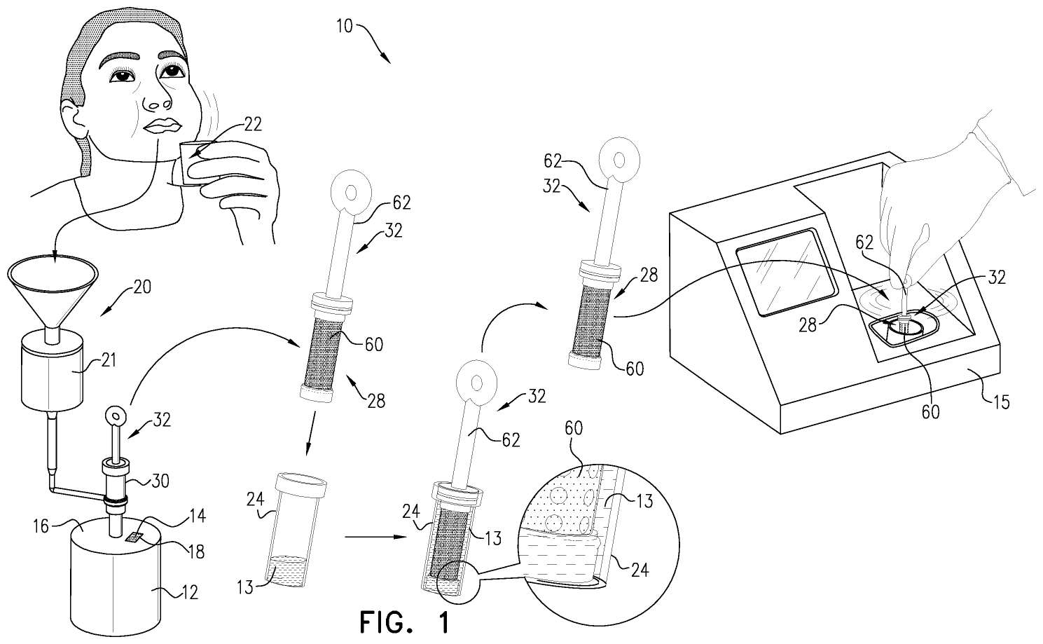

FIG. 1 is a schematic illustration of a liquid-specimen-sample processing system 10, in accordance with an application of the present invention. Liquid-specimen-sample processing system 10 comprises a filter unit 20 for filtering a liquid specimen sample 22. Although liquid-specimen-sample processing system 10 is illustrated as comprising filter unit 20, liquid-specimen-sample processing system 10 may alternatively comprise any of the other filter units described herein, mutatis mutandis.

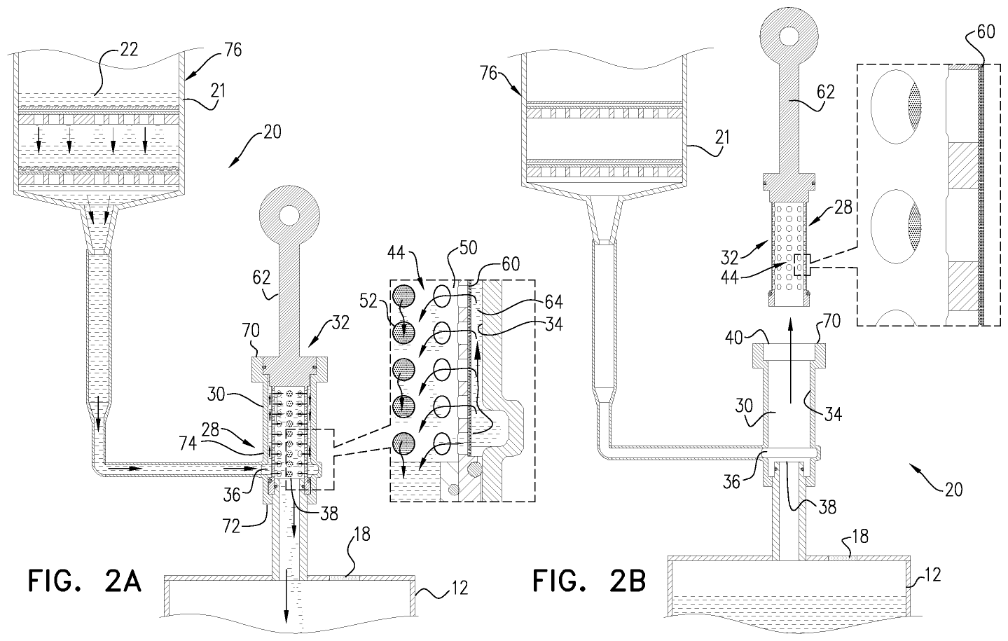

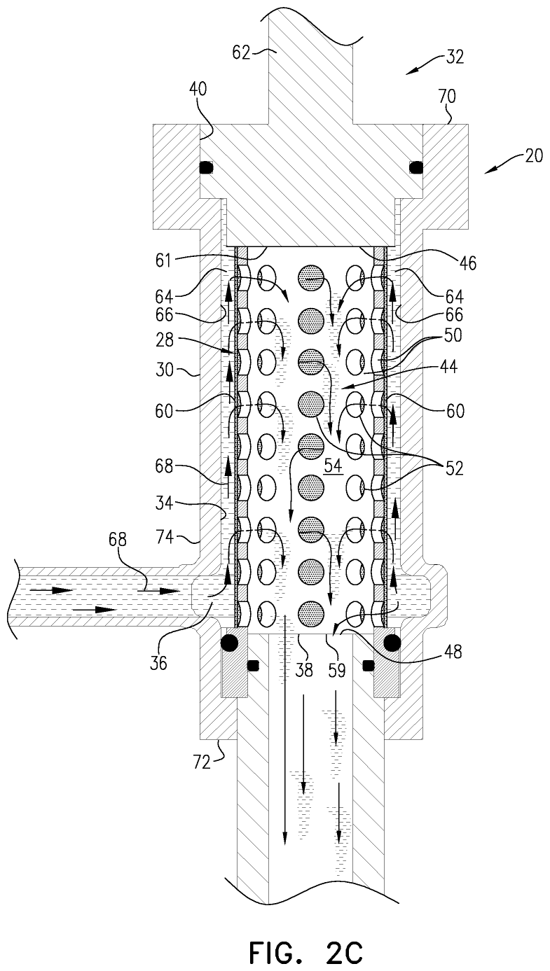

Reference is also made to FIGS. 2A-C, which are schematic illustrations of filter unit 20, in accordance with an application of the present invention. Filter unit 20 comprises a filtration chamber 30 and a filter assembly 32. Filter assembly 32 is configurated to be partially inserted in filtration chamber 30, as shown in FIGS. 2A and 2C, and typically is entirely removable from filtration chamber 30 using a handle 62 of filter assembly 32, as shown in FIG. 2B.

Filtration chamber 30 comprises a filtration-chamber wall 34 that is shaped so as to define a filtration-chamber inlet 36, a filtration-chamber outlet 38, and a filter-assembly opening 40 (labeled in FIGS. 2B and 2C).

As labeled at least in FIG. 2C, filter assembly 32 comprises a filter cartridge 28, which comprises:
a support shell 44, which has proximal and distal ends 46 and 48 (which typically correspond with proximal and distal ends of filter cartridge 28, respectively), and a support-shell side wall 50 that is shaped so as to define one or more support-shell side openings 52 therethrough to an internal space 54 defined by filter cartridge 28 (e.g., by support shell 44); and
a filter 60, which is coupled to support-shell side wall 50 so as to cover the one or more support-shell side openings 52.

Filter assembly 32 further comprises handle 62, which is coupled to proximal end 46 of support shell 44.

Optionally, filtration-chamber inlet 36 is located closer to a distal end of filtration-chamber wall 34 than to a proximal end of the wall, such near (e.g., within 20% of a length of filtration-chamber wall 34) the distal end of filtration-chamber wall 34, as shown. Alternatively, filtration-chamber inlet 36 is located elsewhere along filtration-chamber wall 34 (configuration not shown).

As shown in FIGS. 2A and 2C, filter assembly 32 is partially insertable into filtration chamber 30, such that (a) filter assembly 32 passes through and forms a fluid-tight seal with filter-assembly opening 40 of filtration chamber 30 (labeled in FIGS. 2B and 2C), (b) handle 62 is disposed outside filtration chamber 30, and (c) filter cartridge 28 is disposed (typically, entirely) within filtration chamber 30 such that filter unit 20 defines:
a filtration-chamber space 64 within filtration chamber 30 between an inner surface 66 of filtration-chamber wall 34 and filter cartridge 28, and
a fluid flow path 68 from filtration-chamber inlet 36 to filtration-chamber outlet 38, fluid flow path 68 providing fluid communication among filtration-chamber space 64, the one or more support-shell side openings 52, and filter 60.

Filter 60 is configured to filter biological particulate from liquid specimen sample 22 when liquid specimen sample 22 is driven along fluid flow path 68 while filter cartridge 28 is disposed within filtration chamber 30.

For some applications, filter 60 is configured to mechanically filter the biological particulate from liquid specimen sample 22 by size-based filtration when liquid specimen sample 22 is driven along fluid flow path 68 while filter cartridge 28 is disposed within filtration chamber 30.

For some applications, filter unit 20 is configured such that when filter cartridge 28 is disposed within filtration chamber 30, filtration-chamber space 64 entirely surrounds support-shell side wall 50, such as shown in FIGS. 2A and 2C.

For some applications, filter 60 entirely surrounds support-shell side wall 50, such as shown in FIGS. 2A-C.

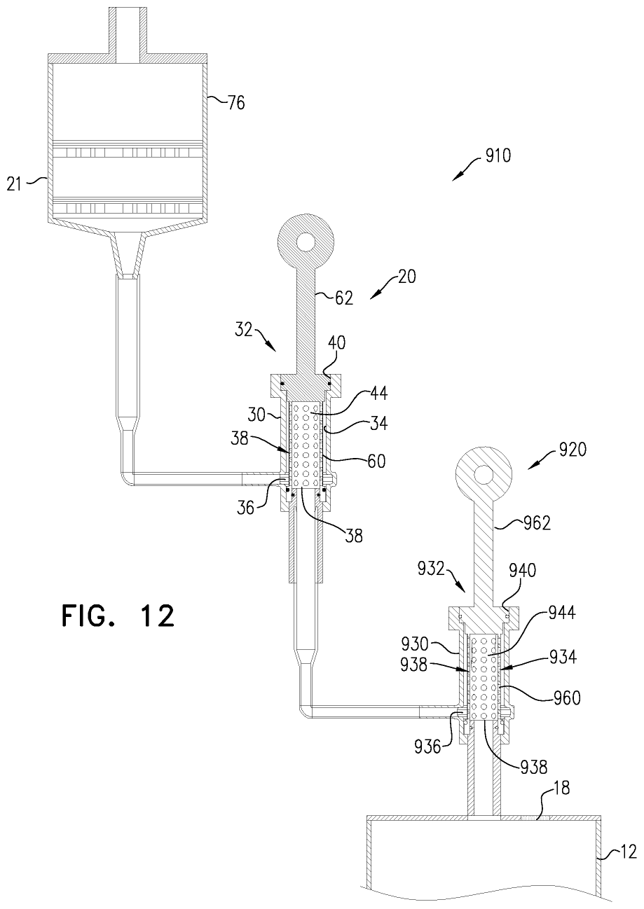

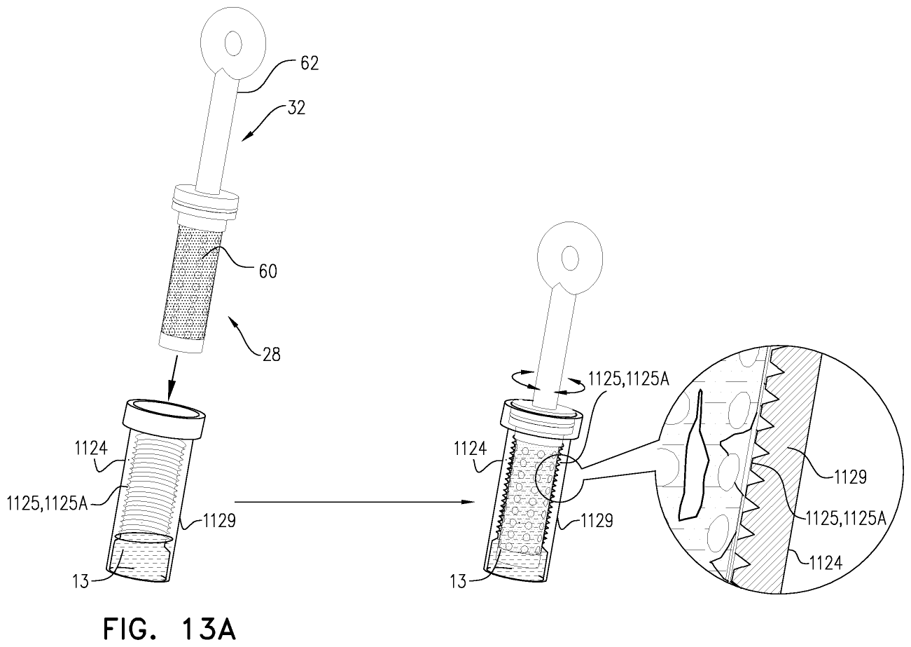

For some applications, filter 60 is tubular, such as shown in FIGS. 2A-C. For example, filter 60 may be circularly cylindrical (such as shown in FIGS. 2A-C), elliptically cylindrical (such as shown for filter assembly 732 in FIG. 10), rectangular (configuration not shown), or spherical (configuration not shown).

For some applications, support shell 44 is tubular, such as shown in FIGS. 2A-C. For example, support shell 44 may be circularly cylindrical (such as shown in FIGS. 2A-C), elliptically cylindrical (such as shown for filter assembly 732 in FIG. 10), rectangular (configuration not shown), or spherical (configuration not shown).

Optionally, filter 60 and/or support shell 44 have a pleated shape or an undulating corrugated shape, which may increase the surface area of filter 60.

For some applications, filter-assembly opening 40 passes through a proximal end 70 of filtration-chamber wall 34, and filtration-chamber outlet 38 passes through a distal end 72 of filtration-chamber wall 34, such as shown in FIGS. 2A and 2C. For some of these applications, filtration-chamber inlet 36 passes through a side portion 74 of filtration-chamber wall 34, such as shown in FIGS. 2A and 2C.

For some applications, such as shown in FIGS. 2A and 2B, liquid-specimen-sample processing system 10 further comprises a fluid-pressure source 76, which is arranged to apply pressure to drive liquid specimen sample 22 along fluid flow path 68. For example, fluid-pressure source 76 may comprise at least one of the following:
a plunger;
a positive-pressure pump (e.g., a hydraulic pump, a syringe, or a motorized and/or electrical pump); optionally, for some application, the positive-pressure pump comprises a chamber with one or more flexible and/or elastic walls, the squeezing of which pumps gas (e.g., air) and/or liquid specimen sample 22 itself out of a liquid container 21 of filter unit 20; and/or
a vacuum pump disposed downstream of filtration chamber 30.

Alternatively or additionally, fluid-pressure source 76 may use centrifugal force to drive liquid specimen sample 22 from liquid container 21.

For some applications, such as shown in FIGS. 2A-C, filter 60 is coupled to an external surface 78 of support-shell side wall 50 so as to cover the one or more support-shell side openings 52. In these applications, filtration-chamber space 64 is defined between inner surface 66 of filtration-chamber wall 34 and filter 60.

Typically, in these applications, distal end 48 of support shell 44 is shaped so as to define a support-shell distal outlet 59, which, when open, is in fluid communication with filtration-chamber outlet 38 when filter cartridge 28 is disposed within filtration chamber 30.

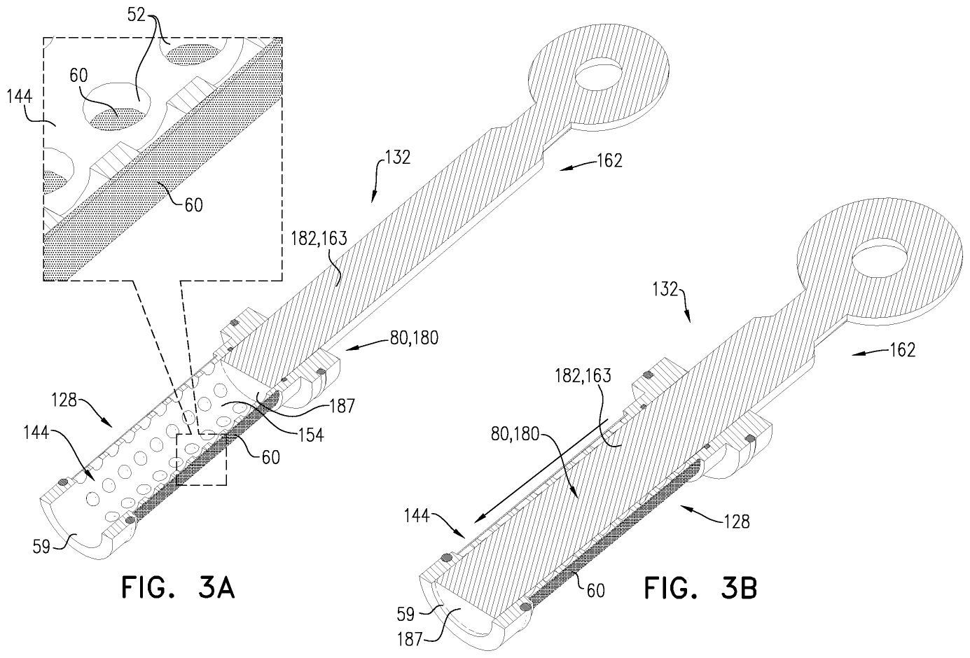

Typically, proximal end 46 of support shell 44 is closed, such as by a distal surface 61 of handle 62 (such as shown in FIGS. 2A-C), a proximal end wall of filtration chamber 30 (configuration not shown), or a distal end 187 of tubular shaft 182 (described hereinbelow with reference to FIGS. 3A-B and 4A-B).

For some of these applications, filter unit 20 is configured such that when filter cartridge 28 is disposed within filtration chamber 30, fluid flow path 68 provides the fluid communication in the following sequence: from filtration-chamber inlet 36, to filtration-chamber space 64, through filter 60, through the one or more support-shell side openings 52 to internal space 54 of filter cartridge 28, and (typically via support-shell distal outlet 59) to filtration-chamber outlet 38, such as shown in FIGS. 2A and 2C.

Filter 60 comprises synthetic or natural materials formed, for example, as a matrix, membrane, fabric, beads, or other configuration. By way of example and not limitation, filter 60 may comprise one of the following filters manufactured by Sterlitech (Washington, USA):
Grade C glass microfiber filter media (Cat. No. C2500 & C3700)
GC-50 glass fiber membrane filters (Cat. No. GC5037100)
polyethersulfone (PES) membrane filters (Cat. No. PES0825100, PES0837100, PES1225100, PES1237100, PES06525100, PES4525100, PES4525100)
polycarbonate membrane filters (Cat. No. PCT0613100, PCT2025100, PCT0625100, PCT1025100, PCT0825100)
cellulose acetate membrane filters (Cat. No. CA0825100)
polyester membrane filters (Cat. No. PET0125100, PET0825100)

For some applications, filter 60 comprises a mechanical filter, which is configured to filter by sized-based filtration. Alternatively or additionally, for some applications, filter 60 comprises fixed antibodies configured to capture biological particulate (e.g., free viral particles) by affinity-based filtration.

For some applications, filter 60 has an absolute or nominal pore size of between 0.01 and 2.0 microns. For some applications, for example, when filter 60 is used for capturing free virus, virions, or viral particles by size-based filtration, filter 60 has a pore size of between 0.01 and 0.3 microns and/or a molecular weight cut off of between 10 kDa and 500 kDa. For some applications, filter 60 has a pore size of between 0.2 and 2.0 microns, for example, when filter 60 is used for capturing bacteria by size-based filtration.

Reference is now made to FIGS. 3A-B, 4A-B, 5A-C, 5D, 6A-B, 7A-B, and 8A-C, which are schematic illustrations of filter assemblies, in accordance with respective applications of the present invention. Each of these filter assemblies is described in detail hereinbelow. In each of these applications, the filter assembly further comprises an occluder 80, which is configured to selectively occlude at least 50% of a volume of the internal space of the filter cartridge, such as at least 80%, e.g., at least 90%, such as at least 95%, e.g., at least 98% or at least 99%, such as 100%, of the volume of the internal space of the filter cartridge. Alternatively, for some applications, occluder 80 is configured to selectively occlude as little as 40%, for example, as little as 25% of the volume of the internal space of the filter cartridge. One purpose of occluder 80 (reducing the amount of liquid medium 13 that flows into internal space 54 of filter cartridge 28) is described hereinbelow with reference to FIG. 1.

For some applications, such as shown in FIGS. 3A-B, 4A-B, 7A-B, and 8A-C, occluder 80 is configured to selectively occlude at least 50% of a volume of the internal space of the filter cartridge by selectively occupying at least 50% of the volume of the internal space of the filter cartridge (or at least the other occlusion percentages mentioned above).

For some applications, such as shown in FIGS. 3A-B, 4A-B, 5A-C, 5D, and 6A-B, occluder 80 is integrated into filter assembly 32 (optionally, permanently integrated), and is configured to selectively assume:
a non-occluding configuration, such as shown in FIGS. 3A, 4A, 5A, and 6A, in which occluder 80 does not occlude at least 50% of the volume of the internal space of the filter cartridge (or at least the other occlusion percentages mentioned above), and
an occluding configuration, such as shown in FIGS. 3B, 4B, 5B, and 6B, in which occluder 80 occludes at least 50% of the volume of internal space 54 (or at least the other occlusion percentages mentioned above).

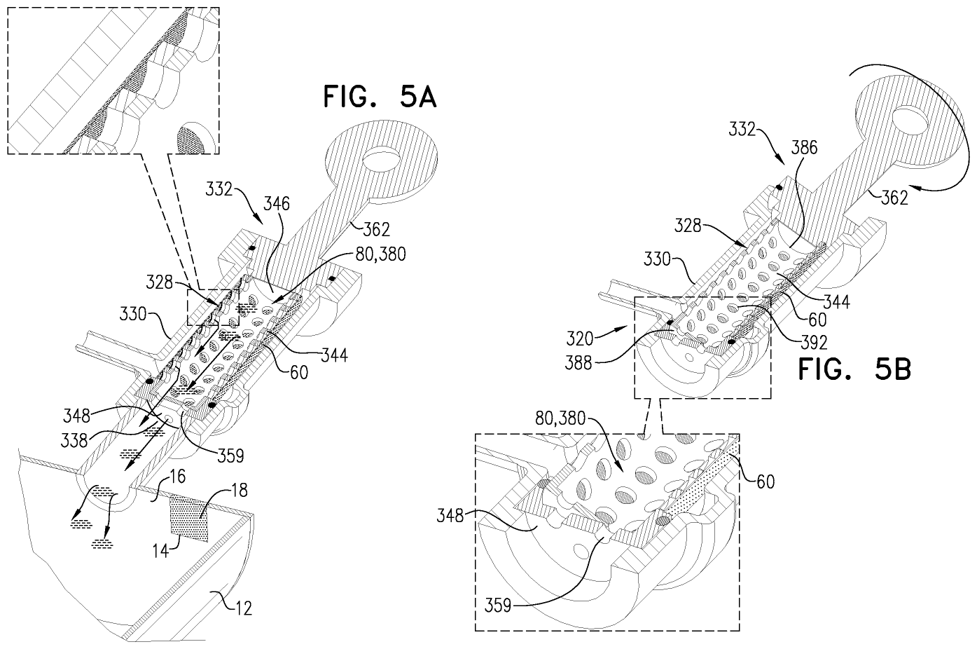

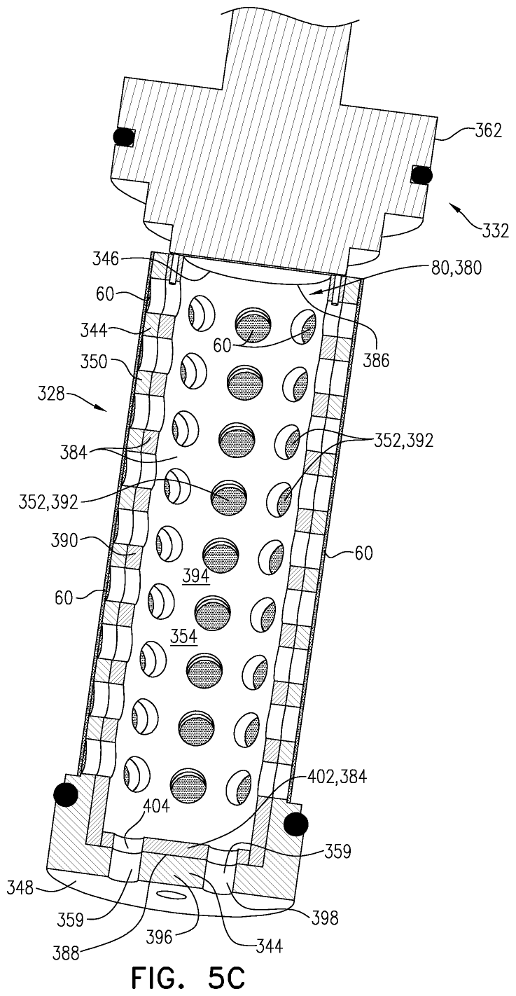

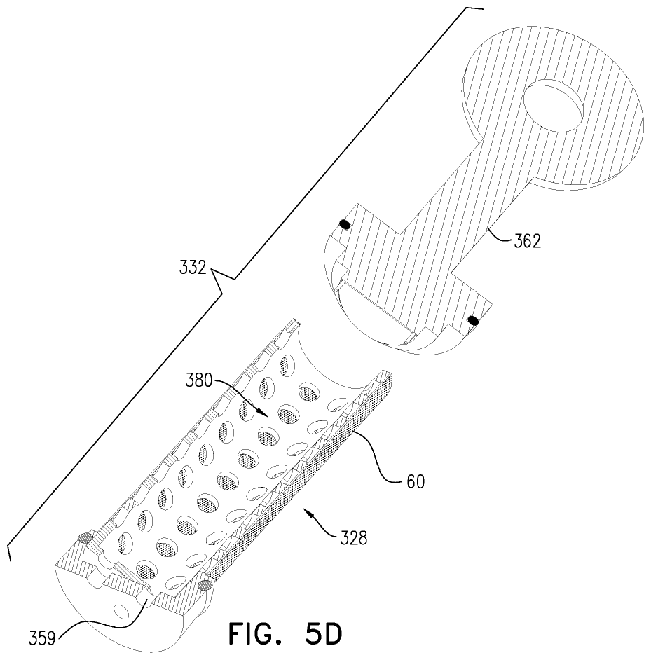

For some applications, such as described hereinbelow with reference to FIGS. 3A-B, 4A-B, 5A-C, 5D, 6A-B, and 8A-C, the handle of the filter assembly is coupled to oceluder 80, such that movement of handle 62 with respect to the support shell transitions occluder 80 from the non-occluding configuration to the occluding configuration. For example, such movement may be axial (such as described hereinbelow with reference to FIGS. 3A-B, 4A-B, and 8A-C) or rotational (such as described hereinbelow with reference to FIGS. 5A-C, 5D, and 6A-B).

Reference is again made to FIGS. 2A-C. For some applications, filter unit 20 further comprises a motor that is configured to agitate filter cartridge 28 when filter cartridge 28 is disposed within filtration chamber 30. Alternatively or additionally, for some applications, filter cartridge 28 is agitated after filter assembly 32 has been entirely removed from filtration chamber 30, optionally while filter cartridge is immersed in liquid medium 13, such as described hereinbelow with reference to FIG. 1.

Reference is still made to FIGS. 2A-C. For some applications, internal space 54 of filter cartridge 28 has a volume of between 0.1 and 100 cc, for example, between 0.1 and 10 cc, for example, between 0.1 and 1 cc.

For some applications, filter cartridge 28 has one or more of the following dimensions:
a length of between 2 and 100 mm, e.g., between 2 and 50 mm, such as between 2 and 30 mm,
a greatest external width, measured perpendicular to the length, of between 4 and 25 mm, such as between 5 and 15 mm (the greatest external width corresponds with the external diameter for configurations in which the filter cartridge is circularly cylindrical), and/or
an external cross-sectional area, measured perpendicular to the length, of between 12.5 and 2000 mm2.

For some applications, filter 60 of filter cartridge 28 has one or more of the following dimensions:
an average thickness of between 20 microns and 2 mm, such as between 20 microns and 1 mm, e.g., between 20 and 500 microns, such as between 50 and 300 microns, e.g., between 100 and 150 microns, and/or
a surface area of between 5 and 20 cm2.

Reference is still made to FIGS. 2A-C. For some applications, filter cartridge 28 comprises a single filter 60, such as shown, or a single filter layer comprising a plurality of filters adjacent one another (configuration not shown). For other applications, filter cartridge 28 comprises a plurality of layered filters, optionally separated by a separator (e.g., a mesh or a larger-pore filter (for example, having a thickness of 90-100 microns)); the filters may have the same or different properties, including, but not limited to, thicknesses and average absolute or nominal pore sizes. (For example, the more outer filter(s) may have larger pore sizes than the more inner filter(s).)

Reference is again made to FIG. 1. During use of liquid-specimen-sample processing system 10, liquid specimen sample 22 is driven into filtration-chamber inlet 36 (labeled in FIGS. 2A-C). For some applications, filter unit 20 comprises liquid container 21 into which liquid specimen sample 22 is placed and from which liquid specimen sample 22 is driven into filtration-chamber inlet 36, either directly or via one or more connecting tubes. Optionally, liquid container 21 may comprise one or more filters and/or filter supports arranged within the filtration chamber downstream of one or more filters, respectively, so as to mechanically support the one or more filters, respectively. The one or more filters provide pre-filtration of liquid specimen sample 22 before liquid specimen sample 22 is driven into filtration-chamber inlet 36 (labeled in FIGS. 2A-C).

Typically, liquid specimen sample 22 is a non-centrifuged liquid specimen sample, which is optionally taken from the respiratory system of the human or non-human animal. For some applications, liquid specimen sample 22 comprises nasal fluid samples taken from one or more of oronasopharyngeal cavities of the human or non-human animal. For some applications, the non-centrifuged oronasopharyngeal liquid specimen sample includes:
a non-centrifuged nasal wash taken from the human or non-human animal,
non-centrifuged nasal aspirate taken from the human or non-human animal,
non-centrifuged gargled fluid taken from the human or non-human animal,
non-centrifuged throat wash taken from the human or non-human animal,
oral wash taken from the human or non-human animal,
material (liquid and/or solid) from (a) (i) a nasal swab or (ii) a nasopharyngeal swab mixed with (b) (i) the non-centrifuged gargled fluid and/or (ii) the nasal wash, and/or
any combination of the above fluid samples, which may increase sensitivity.

Alternatively or additionally, for some applications, nasal wash fluid is intranasally dispensed into the nasal cavity such that the nasal wash fluid passes from the nasal cavity into an oropharynx of the subject via a nasopharynx of the subject. Thereafter, a liquid specimen sample is collected that passed out of an anterior opening (i.e., the mouth) of an oral cavity of the subject and contains at least a portion of the nasal wash fluid. Optionally, before the liquid specimen sample is collected, oral wash fluid is orally dispensed into the oral cavity via the anterior opening of the oral cavity such that the oral wash fluid forms a mixture with the nasal wash fluid in the oropharynx. The subject gargles the mixture. The liquid specimen sample that passed out of the anterior opening of the oral cavity contains at least a portion of the mixture. Alternatively or additionally, the liquid specimen sample is collected using techniques described in U.S. Provisional Application 63/020,723, filed May 6, 2020; U.S. Provisional Application 63/037,707, filed Jun. 11, 2020; and/or U.S. Provisional Application 63/067,535, filed Aug. 19, 2020, all of which are assigned to the assignee of the present application and incorporated herein by reference.

For some applications, such as shown in FIG. 1, liquid specimen sample 22 is received from a patient's mouth. For some applications, liquid specimen sample 22 comprises gargled fluid, i.e., a gargle fluid that the patient has gargled in his or her mouth and spit out, perhaps along with some saliva. In the present application, including in the claims, “gargled fluid” means “gargle fluid” that has been gargled by a patient. Typically, the gargle fluid includes water, carbonated water, saline (e.g., phosphate buffered saline), Pelargonium sidoides extract, tannic acid, balloon flower Platycodon grandiflorus, berberine sulfate, S-carboxymethylcysteine, curcumin, coloring, flavoring, a detergent (such as Polysorbate 20 (e.g., Tween® 20)), or any combination thereof. For some applications, the gargle fluid is carbonated. Alternatively or additionally, for some applications, a detergent, such as Polysorbate 20 (e.g., Tween® 20) is added to the gargled fluid after being gargled by the patient. Alternatively, liquid specimen sample 22 may comprise another type of biological fluid, such as blood (e.g., diluted blood), urine, stool (e.g., diluted stool), gastrointestinal (GI) fluid, or bronchoalveolar lavage fluid.

Alternatively, liquid specimen sample 22 comprises saliva not swabbed from the throat of a patient (i.e., the saliva was collected without swabbing the patient's throat). (The distinction between “swab” as a verb and as a noun is noted. A “swab” (as a noun) may be used to obtain saliva without “swabbing” (as a verb) the patient's throat. For example, the patient may suck on a swab, or a swab may be dipped in a container into which gargle fluid or saliva has been placed.) By contrast, in commonly-practiced techniques for testing for strep, the tonsils are swabbed. Further alternatively, liquid specimen sample 22 comprises liquid from a cultured medium containing an incubated biological sample.

Liquid specimen sample 22 (e.g., saliva) may be spit directly by the patient into liquid container 21 or transferred by a healthcare worker from another container into which the patient spit. Alternatively, in the case of saliva, the saliva may be collected from the patient's mouth by having the patient suck on a swab or other absorbent collecting element, such as flocked swabs or cotton rolls.

Reference is still made to FIG. 1. After the driving of liquid specimen sample 22 into filtration-chamber inlet 36 (and thus along fluid flow path 68 and out of filtration-chamber outlet 38), filter assembly 32 is entirely removed from filtration chamber 30 using handle 62, typically using only 62 handle, without otherwise touching filter 60, such as shown in FIG. 1. The shape of filter cartridge 28 (e.g., the cylindrical shape) allows easy removal from filtration chamber 30, while preventing direct handling of the filter by hand or with forceps, which might lead to contamination of surfaces by the filter, or contamination of the filter itself. In addition, filter cartridge 28 can be easily removed from filtration chamber 30 without damaging filter 60, which may be fragile (for example, may disintegrate upon touch, like some glass microfiber filters).

Reference is still made to FIG. 1. For some applications, after filter assembly 32 has been entirely removed from filtration chamber 30, filter assembly 32 is transported while filter 60 is at least partially (typically, entirely) immersed in a liquid medium 13 contained in a receptacle 24 (e.g., a vial), such as shown in FIG. 1. The shape of filter cartridge 28 (e.g., the cylindrical shape) allows easy insertion of the filter into receptacle 24. Without filter cartridge 28, a filter might need to be folded and/or bunched up, such as using forceps, which is inconvenient and may cause contamination of surfaces by the filter, or contamination of the filter itself during handling. Avoiding folding or bunching of the filter may also increase access to the filter by liquid medium 13, which may improve elusion or lysing of biological particulate trapped by filter 60.

For example, liquid medium 13 may comprise a transport medium, a culture medium, a purification agent, a stabilizing agent, a lysing buffer, or an extraction agent. For example, the transport medium may be a viral transport medium, such as Universal Transport Medium™ (UTM®) (Copan Italia spa, Italy). For example, the culture medium may be a liquid bacterial culture medium that is incubated for enhancing bacterial growth, such as Todd Hewitt Broth (e.g., distributed by Sigma Aldrich (Missouri, USA)), which is often used for Streptococcus bacteria growth, and/or Tryptic Soy Broth, which is often used for general purpose bacterial growth, and may also include selective agents to inhibit the growth of some microbes. For example, the purification agent may be a saliva purification agent, such as Proteinase K. For example, the stabilizing agent may be a DNA stabilizing agent, such as Tris EDTA (TE) buffer and/or Tris Acetate EDTA (TAE). For example, the lysing buffer may be a lysing agent and stabilizing agent, such as “Cobas omni Lysis Reagent (LYS)” as used for the Cobas COVID-19 PCR detection system. For example, the extraction agent may be an antigen extraction agent that acts to extract and/or expose antigens for detection, such as Sodium Nitrite and/or acetic acid often used for extraction of Lancefield antigens from Streptococcus bacteria.

Reference is still made to FIG. 1. For some applications in which filter assembly 32 further comprises occluder 80, the occluder is transitioned to the occluding configuration before filter cartridge 28 is immersed in liquid medium 13 contained in receptacle 24. Occluder 80 reduces the amount of liquid medium 13 that flows into internal space 54 of filter cartridge 28 (optionally, entirely prevents flow into internal space 54, in applications in which occluder 80 occludes 100% of the volume of internal space 54). This reduction reduces the volume of liquid medium 13 necessary for transport of filter 60, which reduces the dilution of any biological particulate trapped by filter 60, thereby increasing the sensitivity of the subsequent testing for the biological particulate.

Reference is still made to FIG. 1. For some applications, filter assembly 32 is partially inserted into receptacle 24 using handle 62 (typically using only handle 62, without otherwise touching filter 60), such that at least a portion of handle 62 is outside receptacle 24 and at least a portion (typically, an entirely) of filter cartridge 28 is disposed within receptacle 24, such as shown in FIG. 1. For these applications, filter assembly 32 passes through and typically forms a fluid-tight seal with an opening of receptacle 24.

For some applications, filter assembly 32 has the general shape and size of a conventional swab, with handle 62 and filter cartridge 28 corresponding to the applicator stick and absorbing swab material, respectively. Thus, filter assembly 32 can be handled and processed using conventional analysis techniques and equipment that are widely available, optionally with minimal or no modifications to conventional processing procedures.

For other applications, handle 62 is removed by the user from filter cartridge 28, such as described hereinbelow with reference to FIG. 5D regarding handle 362. Filter cartridge 28 is then placed, typically entirely, within receptacle 24, which is then closed using a cap.

For some applications, receptacle 24 is integrated into filter unit 20, with the opening of receptacle 24 accessible from outside filter unit 20. Typically, receptacle 24 is not in fluid communication with any other chambers of filter unit 20.

Reference is still made to FIG. 1. After filter assembly 32 has been entirely removed from filtration chamber 30, and, optionally, filter cartridge 28 (and, typically, all of filter assembly 32) has been transported to a testing laboratory, the method further comprises testing for the presence of the biological particulate trapped by filter 60. Alternatively, testing for the present of the biological particulate trapped by filter 60 is performed locally, without transporting to a testing laboratory, such as at home or in a physician's office.

Reference is still made to FIG. 1. For some applications, in order to test for the presence of the biological particulate, at least a portion of liquid medium 13 (such as a few drops) is inserted into a testing machine 15, either with or without filter cartridge 28. For example, the at least a portion of liquid medium 13 may be transferred to a PCR tube, which is inserted into the thermal cycler, as is known in the art.

For some applications, the testing machine 15 is a nucleic acid amplification instrument for qualitative and/or quantitative detection of a particulate, such as thermal cycler (also known as a PCR machine) or an isothermal amplification instrument. For some applications, the testing machine 15 is a spectrometer instrument, a spectroscope, or another spectral device, for qualitative and/or quantitative detection of a particulate. Alternatively, filter cartridge 28 is inserted into testing machine 15.

For some applications, in order to test for the presence of the biological particulate, at least a portion of liquid medium 13 is inserted into a test cassette (not shown). For some applications, the test cassette is then inserted into testing machine 15. For some applications, the test cassette is not inserted into testing machine 15.

For some applications, in order to test for the presence of the biological particulate, a test dipstick (not shown) is placed in contact with at least a portion of liquid medium 13 in which filter 60 was immersed, typically within receptacle 24. For example, the test dipstick may be inserted into receptacle 24 containing liquid medium 13, while filter cartridge 28 is either inside or outside receptacle 24. For some applications, the test dipstick comprises a lateral-flow immunoassay. For example, the lateral-flow immunoassay test may test for Streptococcus bacteria or for SARS-CoV-2, in which case the lateral-flow immunoassay test may, for example, comprise:
a BinaxNOW™ lateral-flow immunoassay test (COVID-19 Ag Card), which tests for COVID-19 antigens (Abbott Laboratories, Chicago, IL, USA);
a Sofia® SARS Antigen Fluorescent Immunoassay Antigen (FIA) lateral-flow test, which tests for COVID-19 antigens (Quidel Corporation, San Diego, USA);
a BD Veritor™ System for Rapid Detection of SARS-CoV-2 (BD (Becton, Dickinson and Company), NJ, USA); or
a LumiraDx™ SARS-CoV-2 Ag Test (LumiraDx UK Ltd., UK).

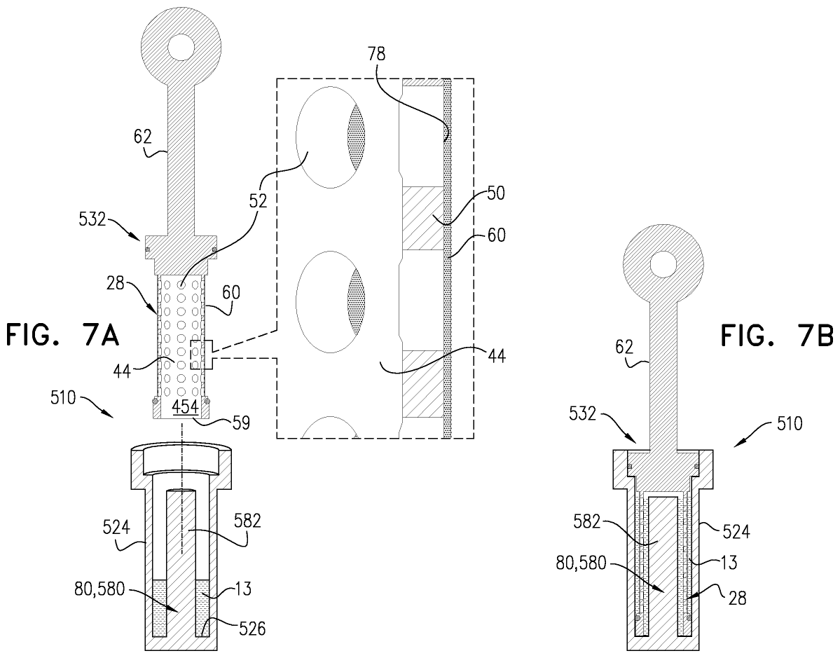

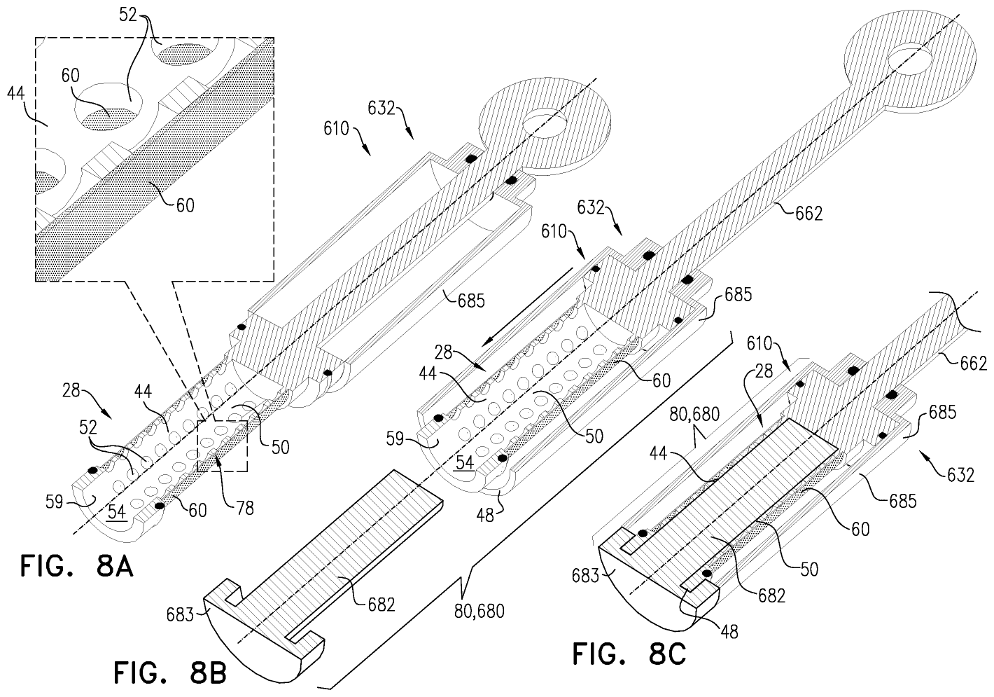

For some applications, filter 60 is agitated, cut, torn, macerated, and/or scraped, either while in contact with liquid medium 13 or before being brought into contact with liquid medium 13. For example, filter 60 may be agitated, cut, torn, macerated, and/or scraped while in contact with at least a portion of liquid medium 13 by mixing filter 60 in liquid medium 13. For example, handle 62 may be used to mix filter 60 in liquid medium 13, for example while filter cartridge 28, containing filter 60, is contained within receptacle 24 or within receptacle 524, described hereinbelow with reference to FIGS. 7A-B.

For example, the testing may be performed using a nucleic acid amplification technique, such as polymerase chain reaction (PCR) assaying (e.g., quantitative polymerase chain reaction (qPCR) assaying), or isothermal amplification, e.g., using Alere™ i (Abbott Laboratories, Waltham, Massachusetts, USA).

For some applications, testing for the presence of the biological particulate comprises incubating filter 60 in a growth medium, optionally while filter 60 remains attached to support shell 44, i.e., while filter cartridge 28 remains intact. Alternatively, filter 60 is removed from support shell 44 and, optionally, cut, torn, macerated, agitated, and/or scraped before incubation.

For some applications, fluid-pressure source 76 is configured to pump gas (e.g., air) into filtration-chamber inlet 36 to complete the driving of liquid specimen sample 22 into filtration-chamber inlet 36.

For some applications in which filter assembly 32 comprises occluder 80, a user, after finishing driving liquid specimen sample 22 into filtration-chamber inlet 36 (and after liquid specimen sample 22 has passed out of filtration-chamber outlet 38), transitions occluder 80 from the non-occluding configuration to the occluding configuration.

Alternatively, occluder 80 is configured to automatically transition from the non-occluding configuration to the occluding configuration after liquid specimen sample 22 has been driven into filtration-chamber inlet 36.

For some applications, occluder 80 is transitioned from the non-occluding configuration to the occluding configuration before filter assembly 32 is entirely removed from filtration chamber 30. For some of these applications, filter unit 20 comprising a lock that prevents removal of filter assembly 32 from filtration chamber 30 when occluder 80 is still in the non-occluding configuration, and allows removal of filter assembly 32 from filtration chamber 30 after occluder 80 has been transitioned to the occluding configuration.

Alternatively, for some applications, occluder 80 is transitioned from the non-occluding configuration to the occluding configuration after filter assembly 32 is entirely removed from filtration chamber 30.

Further alternatively, for some applications, occluder 80 is transitioned from the non-occluding configuration to the occluding configuration during removal of filter assembly 32 from filtration chamber 30, optionally automatically by filter unit 20.

Still further alternatively, for some applications, occluder 80 is transitioned from the non-occluding configuration to the occluding configuration during partial insertion of filter assembly 32 into receptacle 24, optionally automatically by filter assembly 32 and/or receptacle 24.

For some applications of the present invention, liquid specimen sample 22 contains biological material such microorganisms, antigens, human cells, extracellular soluble and non-soluble particles, cellular components and products, blood products, cellular biomarkers, hormones, vitamins, electrolytes, chemical mediators from cells such as mediators of inflammation, pollens, mucous, saliva, sputum, respiratory particles, droplets derived from the upper and lower airways, and chemicals originating from external vapors. As used in the present application, including in the claims, microorganisms may include either pathogenic microorganisms or non-pathogenic microorganisms or both, for example, viruses, bacteria, protozoa, and fungi.

In applications in which the biological material includes a virus, the virus may include free virions (i.e., extracellular virions) and/or intracellular virus, which, optionally are released from cells (e.g., epithelial cells) of the biological material after collection of the specimen sample and before testing the presence of the virus.

For some applications, testing for the presence of the biological particulate comprises testing to aid in the diagnosis of disease, for example, aiding in the diagnosis of infectious diseases or allergies. For some applications, testing the one or more specimen samples for the presence of the biological particulate comprises testing to aid in the diagnosis of a biological status or inflammatory status. For some applications, testing for the presence of the biological particulate includes testing for the presence of one or more of the following soluble or insoluble biological particulates: a pathogenic microorganism, a non-pathogenic microorganism, an antigen, a human cell, a cellular biomarker, a hormone, a chemical mediator from cells such as a mediator of inflammation, a pollen, a respiratory particle, a particle contained within droplets from the lower airways of the subject, a nucleic acid including DNA and RNA, and a chemical originating from an external vapor. For some applications, testing for the presence of the biological particulate includes testing for the presence of one or more of the following microorganisms: viruses, bacteria, and fungi, e.g., testing for the presence of bacteria, for example, Streptococcus bacteria, such as Streptococcus pyogenes (Strep A), or, for example, testing for the presence of viruses such as Influenza viruses, or for example, coronaviruses such as SARS-CoV-2. For some applications, the specimen sample is tested for the presence of cerebrospinal fluid (CSF).

For some applications, the testing for the presence of the biological particulate includes testing for the presence of one or more of the following antigens: viral antigens, bacterial antigens, and fungal antigens.

For some applications, testing for the presence of the biological particulate comprises using one or more of the following testing techniques: microscopic imaging, fluorescence-activated cell sorting (FACS), spectroscopy, microscopy, and/or CRISPR diagnostic testing. For some applications, testing comprises culturing at least a portion of the specimen sample. For some applications, testing comprising performing a biological particulate detection test selected from the group consisting of: an immunoassay, for example, an enzyme-linked immunosorbent assay (ELISA), or for example, a lateral-flow immunochromatographic assay; and a molecular-based assay, for example, nucleic acid hybridization, or for example, nucleic acid amplification, including polymerase chain reaction (PCR) amplification, real-time quantitative PCR (qPCR) amplification, reverse transcriptase PCR (RT-PCR) amplification, and isothermal amplification.

Reference is still made to FIG. 1. For some applications, liquid-specimen-sample processing system 10 further comprises a waste liquid receptacle 12, which is coupled to filtration chamber 30 in fluid communication with filtration-chamber outlet 38 (labeled in FIGS. 2A-C). Optionally, waste liquid receptacle 12 is shaped so as to define an opening 14 through an external wall 16 of waste liquid receptacle 12 to release displaced air. For example, opening 14 may be located on a top portion of external wall 16 (as shown) or a side portion of external wall 16 (configuration not shown). For some applications, waste liquid receptacle 12 comprises an air filter 18 (e.g., an N98 filter) that is disposed to filter air that passes out of waste liquid receptacle 12 through opening 14. Alternatively or additionally, for some applications, waste liquid receptacle 12 comprises a one-way pressure-sensitive valve disposed in opening 14.

Reference is now made to FIGS. 3A-B and 4A-B, which are schematic illustrations of a filter assembly 132 and a filter assembly 232, in accordance with respective applications of the present invention. Filter assemblies 132 and 232 are implementations of filter assembly 32, described hereinabove with reference to FIGS. 2A-B, and may implement any of the features thereof, mutatis mutandis.

Filter assembly 132 comprises a handle 162, a filter cartridge 128, a support shell 144, and an occluder 180, which are implementations of handle 62, filter cartridge 28, support shell 44, and occluder 80, respectively, described hereinabove with reference to FIGS. 2A-B, and may implement any of the features thereof, mutatis mutandis. Filter assembly 232 comprises a handle 262 instead of handle 162, and is otherwise identical to filter assembly 132.

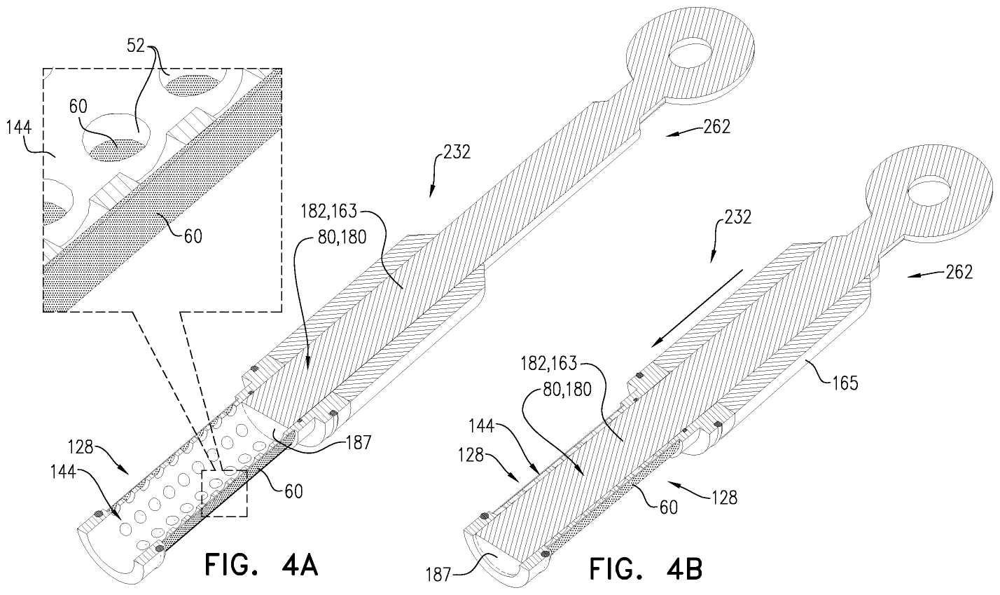

Occluder 180 comprises a tubular shaft 182, which is configured to be disposable:
at least partially outside an internal space 154 defined by filter cartridge 128 (e.g., by support shell 144) when in the non-occluding configuration (in which tubular shaft 182 does not occlude at least 50% of the volume of internal space 154), such as shown in FIGS. 3A and 4A, and
at least partially within internal space 154 of filter cartridge 128 when in the occluding configuration (in which tubular shaft 182 occludes at least 50% of the volume of internal space 154), such as shown in FIGS. 3B and 4B.

For some applications, tubular shaft 182 is axially moveable (e.g., slidable) with respect to internal space 154 of filter cartridge 128.

Typically, tubular shaft 182, when in the occluding configuration, also blocks and thus closes support-shell distal outlet 59.

For some applications, a portion 163 of handle 162 or 262 is shaped so as to define tubular shaft 182, such as shown in FIGS. 3A-B and 4A-B. For other applications, tubular shaft 182 is coupled to a distal end of handle 162 or 262 (configuration not shown). It is noted that distal axial advancement (e.g., sliding) of handle 162 or 262, which in turn causes distal axial advancement (e.g., sliding) of tubular shaft 182 into internal space 154 of filter cartridge 128, does not materially drive liquid specimen sample 22 through filter 60. (However, such advancement may drive any small amount of liquid specimen sample 22 remaining in internal space 154 out of the internal space via support-shell distal outlet 59 and/or support-shell side openings 52.)

For some applications, such as shown in FIGS. 4A-B, tubular shaft 182 is moveable (e.g., axially, such as slidably) with respect to a radially-outer portion 165 of handle 262 and internal space 154 of filter cartridge 128. Tubular shaft 182:
when in the non-occluding configuration, is disposed at least partially within radially-outer portion 165 of handle 262 outside internal space 154 of filter cartridge 128, such as shown in FIG. 4A, and
when in the occluding configuration, is disposed at least partially outside radially-outer portion 165 of handle 262 within internal space 154 of filter cartridge 128, such as shown in FIG. 4B.

Reference is now made to FIGS. 5A-B which are schematic illustrations of a filter unit 320, in accordance with an application of the present invention. Reference is also made to FIG. 5C, which is a schematic illustration of a portion of filter assembly 332 of filter unit 320, in accordance with an application of the present invention. Filter unit 320 is an implementation of filter unit 20, described hereinabove with reference to FIGS. 2A-B, and may implement any of the features thereof, mutatis mutandis.

Filter unit 320 comprises a filtration chamber 330 (only a portion of which is shown in FIGS. 5A-B) and filter assembly 332. Filtration chamber 330 and filter assembly 332 are implementations of filtration chamber 30 and filter assembly 32, described hereinabove with reference to FIGS. 2A-B, and may implement any of the features thereof, mutatis mutandis.

Filter assembly 332 comprises a handle 362, a filter cartridge 328, and a support shell 344, which are implementations of handle 62, filter cartridge 28, and support shell 44, respectively, described hereinabove with reference to FIGS. 2A-B, and may implement any of the features thereof, mutatis mutandis. Filter assembly 332 further comprises and an occluder 380, which is an implementation of occluder 80, described hereinabove with reference to FIGS. 3A-B, 4A-B, 5A-C, 5D, 6A-B, 7A-B, and 8A-C, and may implement any of the features thereof, mutatis mutandis. Occluder 380 is integrated into filter assembly 332, typically permanently. For clarity of illustration in FIG. 5C, filtration chamber 330 is not shown, even though occluder 380 is typically not in the non-occluding configuration when filter cartridge 328 is still disposed within filtration chamber 330.

As labeled in FIG. 5C, support shell 344 has proximal and distal ends 346 and 348, and a support-shell side wall 350 that is shaped so as to define one or more support-shell side openings 352 therethrough to an internal space 354 defined by filter cartridge 328 (e.g., by support shell 344).

Occluder 380 comprises an occluder shell 384, which has proximal and distal ends 386 and 388, and an occluder-shell side wall 390 that is shaped so as to define one or more occluder-shell side openings 392 therethrough to an internal space 394 defined by occluder shell 384, as labeled in FIG. 5C.

Typically, proximal end 386 is coupled to handle 362.

Distal end 348 of support shell 344 is shaped so as to define a support-shell distal outlet 359, which, when open (as shown in FIGS. 5A and 5C), is in fluid communication with a filtration-chamber outlet 338 when filter cartridge 328 is disposed within filtration chamber 330, as labeled in FIG. 5C.

Occluder shell 384 is disposed within support shell 344, and rotatable with respect to support shell 344 to set an alignment of the one or more occluder-shell side openings 392 with the one or more support-shell side openings 352.

Occluder 380 is configured to selectively assume:
a non-occluding configuration when the one or more occluder-shell side openings 392 are aligned with the one or more support-shell side openings 352, such as shown in FIGS. 5A and 5C, and
an occluding configuration when the one or more occluder-shell side openings 392 are not aligned with the one or more support-shell side openings 352, such as shown in FIG. 5B.

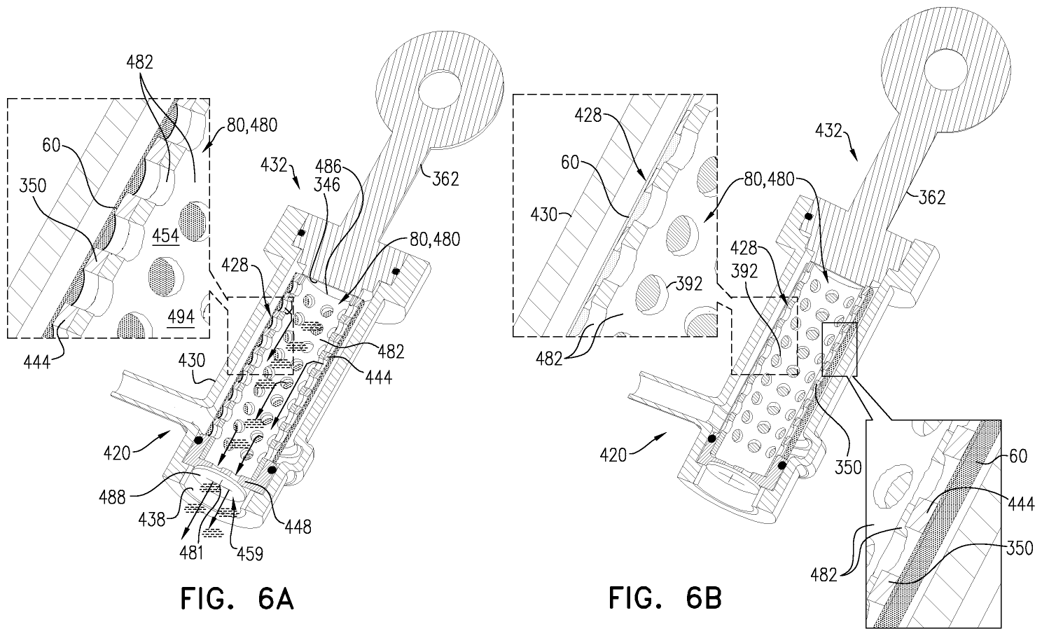

For some applications, filter assembly 332 is configured such that when occluder 380 is in the non-occluding configuration, support-shell distal outlet 359 is open, such as shown in FIGS. 5A and 5C (and for filter cartridge 428 in FIG. 6A, described hereinbelow). By contrast, when occluder 380 is in the occluding configuration, support-shell distal outlet 359 is blocked and thus closed, such as shown in FIG. 5B (and for filter cartridge 428 in FIG. 6B, described hereinbelow).

For some of these applications, support shell 344 is shaped so as to further define, at distal end 348 thereof, and a support-shell distal wall 396 that is shaped so as to define one or more support-shell distal openings 398 therethrough to internal space 354 defined by filter cartridge 328, as labeled in FIG. 5C. Occluder shell 384 is shaped so as to further to define, at distal end 488 thereof, an occluder-shell distal wall 402 that is shaped so as to define one or more occluder-shell distal openings 404 therethrough to internal space 394 defined by occluder shell 384, as labeled in FIG. 5C. Occluder shell 384 is rotatable with respect to support shell 344 to set the alignment of the one or more occluder-shell side openings 392 with the one or more support-shell side openings 352, and an alignment of the one or more occluder-shell distal openings 404 with the one or more support-shell distal openings 398. Occluder 380 is configured to selectively assume:
the non-occluding configuration when the one or more occluder-shell side openings 392 are aligned with the one or more support-shell side openings 352, and the one or more occluder-shell distal openings 404 are aligned with the one or more support-shell distal openings 398, as shown in FIGS. 5A and 5C, and
the occluding configuration when the one or more occluder-shell side openings 392 are not aligned with the one or more support-shell side openings 352, and the one or more occluder-shell distal openings 404 are not aligned with the one or more support-shell distal openings 398, as shown in FIG. 5B.

When occluder 380 is in the non-occluding configuration, support-shell distal outlet 359 is open, such as shown in FIGS. 5A and 5C. By contrast, when occluder 380 is in the occluding configuration, support-shell distal outlet 359 is blocked and thus closed by the support-shell distal wall 396 and occluder-shell distal wall 402 together, such as shown in FIG. 5B.

Reference is made to FIG. 5D, which is a schematic illustration of a configuration of filter assembly 332, in accordance with an application of the present invention. In this configuration, handle 362 is configured to be removable by the user from filter cartridge 328. Similarly, the other handles described herein are optionally configured to be removable by the user from their respective filter cartridges.

Reference is now made to FIGS. 6A-B which are schematic illustrations of a filter unit 420, in accordance with an application of the present invention. Except as described below, filter unit 420 is identical to filter unit 320, described hereinabove with reference to FIGS. 5A-C, and may implement any of the features thereof, mutatis mutandis. Filter unit 420 comprises a filtration chamber 430 and a filter assembly 432.

Filter assembly 432 comprises handle 362, a filter cartridge 428, and a support shell 444, which are implementations of handle 62, filter cartridge 28, and support shell 44, respectively, described hereinabove with reference to FIGS. 2A-B, and may implement any of the features thereof, mutatis mutandis. Filter assembly 432 further comprises and an occluder 480, which is an implementation of occluder 80, described hereinabove with reference to FIGS. 3A-B, 4A-B, 5A-C, 5D, 6A-B, 7A-B, and 8A-C, and may implement any of the features thereof, mutatis mutandis. Occluder 480 is typically permanently integrated into filter assembly 432, or permanently integrated partially into filter assembly 432 and partially into filtration chamber 430. Support shell 444 has proximal end 346 and a distal end 448, and support-shell side wall 350 that is shaped so as to define the one or more support-shell side openings 352 therethrough to an internal space 454 defined by filter cartridge 428 (e.g., by support shell 444).

Occluder 480 comprises an occluder shell 484, which has proximal and distal ends 486 and 488, and occluder-shell side wall 390 that is shaped so as to define the one or more occluder-shell side openings 392 therethrough to an internal space 494 defined by occluder shell 484.

Typically, proximal end 486 is coupled to handle 362.

Distal end 448 of support shell 444 is shaped so as to define a support-shell distal outlet 459, which, when open (as shown in FIG. 6A), is in fluid communication with a filtration-chamber outlet 438 when filter cartridge 428 is disposed within filtration chamber 430.

Occluder shell 484 is disposed within support shell 444, and rotatable with respect to support shell 444 to set an alignment of the one or more occluder-shell side openings 392 with the one or more support-shell side openings 352.

Occluder 480 is configured to selectively assume:
a non-occluding configuration when the one or more occluder-shell side openings 392 are aligned with the one or more support-shell side openings 352, such as shown in FIG. 6A, and
an occluding configuration when the one or more occluder-shell side openings 392 are not aligned with the one or more support-shell side openings 352, such as shown in FIG. 6B.

For some applications, filter assembly 432 is configured such that when occluder 480 is in the non-occluding configuration, support-shell distal outlet 459 is open, such as shown in FIG. 6A. By contrast, when occluder 480 is in the occluding configuration, support-shell distal outlet 459 is blocked and thus closed, such as shown in FIG. 6B.

For some of these applications, occluder 480 further comprises a pressure-activated valve 481 (optionally, a one-way pressure-activated valve) in fluid communication with distal end 448 of support shell 444. Pressure-activated valve 481 may be coupled to (a) distal end 448 of support shell 444 at support-shell distal outlet 459 (as shown), or (b) filtration chamber 430 at a filtration-chamber outlet 438 thereof (configuration not shown).

Reference is now made to FIGS. 7A-B, which are schematic illustrations of a portion of a liquid-specimen-sample processing system 510, in accordance with an application of the present invention. Liquid-specimen-sample processing system 510 is generally similar to liquid-specimen-sample processing system 10, described hereinabove with reference to FIG. 1, and may implement any of the features thereof and comprises any of the elements thereof, mutatis mutandis.

Liquid-specimen-sample processing system 510 comprises a filter assembly 532, which is generally similar to filter assembly 32, described hereinabove with reference to FIGS. 1 and 2A-C. For some applications, filter 60 is coupled to external surface 78 of support-shell side wall 50 so as to cover the one or more support-shell side openings 52, as shown in FIGS. 7A-B, while for other applications, filter 60 is coupled to an internal surface of support-shell side wall 50 (configuration not shown).

Liquid-specimen-sample processing system 510 further comprises a receptacle 524, which contains liquid medium 13, and which is configured to receive a filter cartridge 528. FIG. 7A shows filter cartridge 528 before insertion into receptacle 524, and FIG. 7B shows filter cartridge 528 disposed within receptacle 524 after insertion therein.

Liquid-specimen-sample processing system 510 further comprises an occluder 580, which is configured to selectively occlude at least 50% of a volume of an internal space 454 defined by filter cartridge 428, and which may implement any of the techniques of occluder 80, described hereinabove with reference to FIGS. 3A-B, 4A-B, 5A-C, 5D, 6A-B, 7A-B, and 8A-C, mutatis mutandis, including, but not limited to, the percentage of volume occluded.

Occluder 580 comprises a tubular shaft 582, which is configured to be disposable:
at least partially outside (typically entirely outside) internal space 454 of filter cartridge 428 when in a non-occluding configuration, in which tubular shaft 582 does not occlude at least 50% of the volume of internal space 454, such as shown in FIG. 7A, and
at least partially within internal space 454 of filter cartridge 428 when in an occluding configuration, in which tubular shaft 582 occludes at least 50% of the volume of internal space 454, such as shown in FIG. 7B.

Tubular shaft 582 is axially moveable (typically slidable) with respect to internal space 454 of filter cartridge 428.

Tubular shaft 582 of oceluder 580 is disposed within receptacle 524, protruding upward from a floor 526 of receptacle 524. As a result, when filter cartridge 528 is inserted into receptacle 524, tubular shaft 582 of occluder 580 enters internal space 454 via support-shell distal outlet 59. Support-shell distal outlet 59 is blocked and thus closed by tubular shaft 582 or floor 526 of receptacle 524, or a combination thereof.

As described hereinabove with reference to FIGS. 2A and 2C, when filter assembly 32 is partially inserted into filtration chamber 30 of filter unit 20, a portion of filter assembly 32 passes through and forms a fluid-tight seal with filter-assembly opening 40 of filtration chamber 30. For some applications, this same portion of filter assembly 32 forms a fluid-tight seal with an opening 527 of receptacle 524 when filter assembly 32 is partially inserted into receptacle 524 (and filter cartridge 28 is disposed within receptacle 524).

Reference is now made to FIGS. 8A-C, which are schematic illustrations of a portion of a liquid-specimen-sample processing system 610, in accordance with an application of the present invention. Liquid-specimen-sample processing system 610 is similar in certain respects to liquid-specimen-sample processing system 510, described hereinabove with reference to FIGS. 7A-B, and like reference numerals indicate like parts. Liquid-specimen-sample processing system 610 may implement any of the features and comprise any of the elements of the other liquid-specimen-sample processing systems described herein, mutatis mutandis.

Liquid-specimen-sample processing system 610 comprises a filter assembly 632, which is generally similar to filter assembly 532, described hereinabove with reference to FIGS. 7A-B. Filter assembly 632 comprises an occluder 680, which is configured to selectively occlude at least 50% of a volume of internal space 54 of filter cartridge 28, and which may implement any of the techniques of occluder 80, described hereinabove with reference to FIGS. 3A-B, 4A-B, 5A-C, 5D, 6A-B, 7A-B, and 8A-C, mutatis mutandis, including, but not limited to, the percentage of volume occluded. Typically, a portion of occluder 680 is permanently integrated into filter assembly 632, and a portion of occluder 680 is not permanently integrated into filter assembly 632.

Occluder 680 comprises a tubular shaft 682, which is configured to be disposable:
at least partially outside internal space 54 of filter cartridge 28 when in a non-occluding configuration, in which tubular shaft 682 does not occlude at least 50% of the volume of internal space 54, and
at least partially within internal space 54 of filter cartridge 28 when in an occluding configuration, in which tubular shaft 682 occludes at least 50% of the volume of internal space 54.

Tubular shaft 682 is axially moveable (typically slidable) with respect to internal space 54 of filter cartridge 28. Tubular shaft 682 is configured to be inserted into internal space 54 via support-shell distal outlet 59.

Typically, occluder 680 further comprises a support-shell cover 685 which is axially moveable with respect to support shell 44. Support-shell cover 685 is configured to cover external surface 78 of support-shell side wall 50 (as well as filter 60) to a greater extent when occluder 680 is in the occluding configuration, such as shown in FIGS. 8B and 8C, than when occluder 680 is in the non-occluding configuration, such as shown in FIG. 8A. Support-shell cover 685 may be configured to partially or entirely cover external surface 78 of support-shell side wall 50 (as well as filter 60) when occluder 680 is in the occluding configuration, and to partially or entirely not cover external surface 78 of support-shell side wall 50 (as well as filter 60) when occluder 680 is in the non-occluding configuration.

For some applications, support-shell cover 685 is slidable with respect to a handle 662 of filter assembly 632. For some applications, support-shell cover 685 surrounds handle 662 to a greater extent when occluder 680 is in the non-occluding configuration, such as shown in FIG. 8A, than when occluder 680 is in the occluding configuration, such as shown in FIGS. 8B-C.

For some applications, occluder 680 further comprises an end cover 683 at a distal end 679 of tubular shaft 682. End cover 683 may be integral with tubular shaft 682 or comprise a separate piece attached to tubular shaft 682. As shown in FIG. 8C, end cover 683 is configured to close support-shell distal outlet 59 by being coupled to distal end 48 of support shell 44 and or a distal end of support-shell cover 685 when occluder 680 is in the occluding configuration.

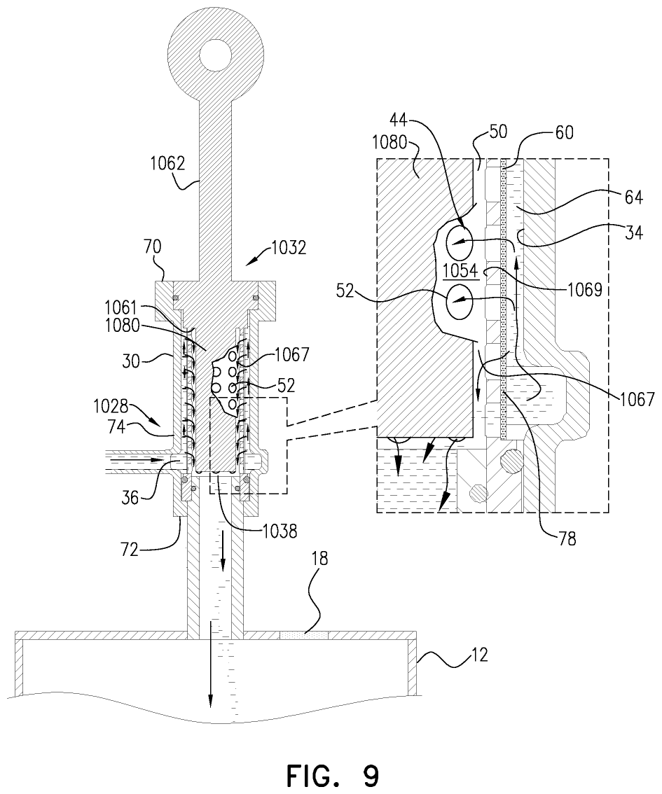

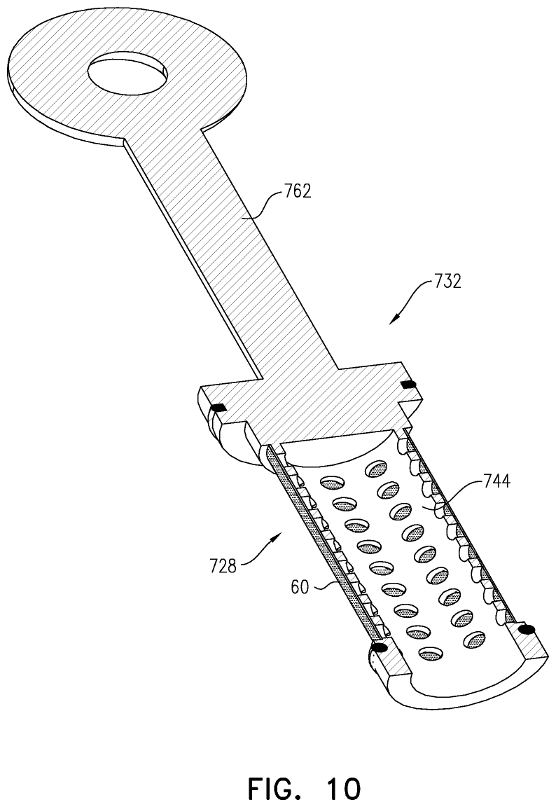

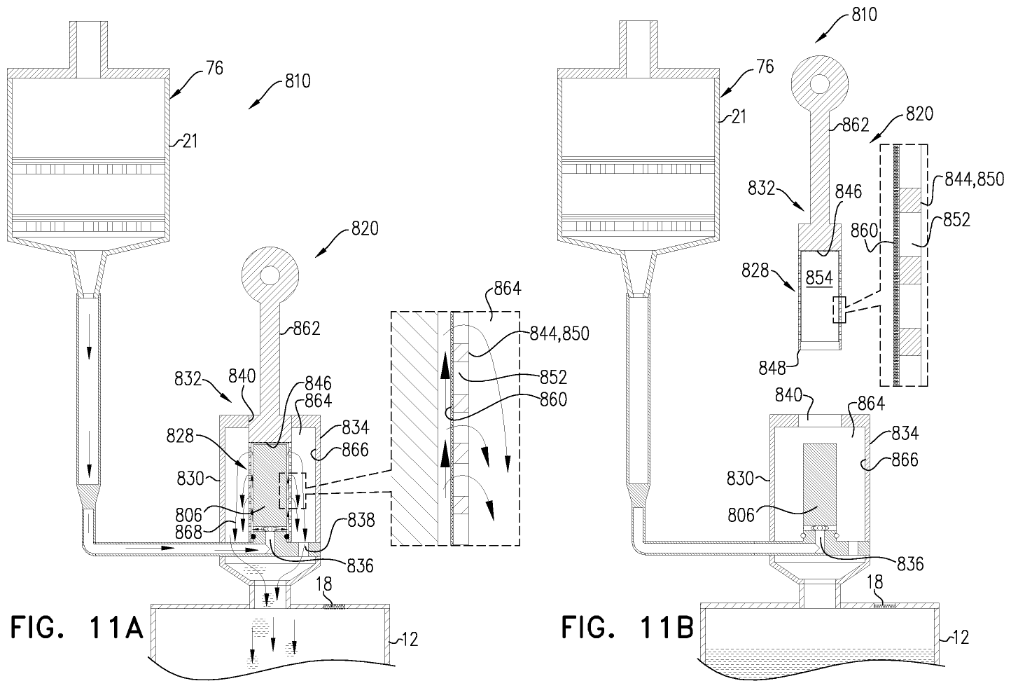

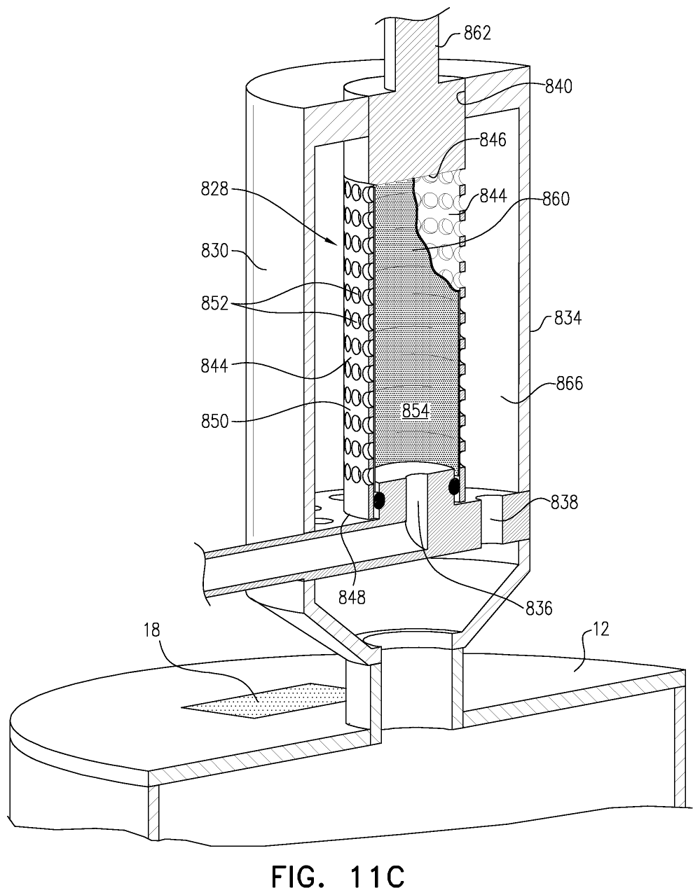

Reference is now made to FIG. 9, which is a schematic illustration of a filter unit 1020, in accordance with an application of the present invention. Filter unit 1020 is an implementation of filter unit 20, described hereinabove with reference to FIGS. 2A-B, and may implement any of the features thereof, mutatis mutandis.

Filter unit 1020 comprises a filtration chamber 1030 and a filter assembly 1032. Filtration chamber 1030 and filter assembly 1032 are implementations of filtration chamber 30 and filter assembly 32, described hereinabove with reference to FIGS. 2A-B, and may implement any of the features thereof, mutatis mutandis.

Filter assembly 1032 comprises a handle 1062 and a filter cartridge 1028, which are implementations of handle 62 and filter cartridge 28, respectively, described hereinabove with reference to FIGS. 2A-B, and may implement any of the features thereof, mutatis mutandis. Filter assembly also comprises support shell 44, described hereinabove with reference to FIGS. 2A-B.

Filter assembly 1032 further comprises and an occluder 1080, which optionally may implement any of the features of occluder 80, described hereinabove with reference to FIGS. 3A-B, 4A-B, 5A-C, 5D, 6A-B, 7A-B, and 8A-C, mutatis mutandis.

Occluder 1080 is disposed within support shell 44 so as to permanently assume an occluding configuration, in which occluder 1080 occludes at least 50% of the volume of an internal space 1054 defined by filter cartridge 1028 (or at least the other occlusion percentages mentioned hereinabove for occluder 80).

Occluder 1080 occludes no more than 99% (e.g., no more than 95%, such as no more than 90%, e.g., no more than 80%) of the volume of internal space 1054 such that filter cartridge 1028 defines a support-shell space 1067 between occluder 1080 and an internal surface 1069 of support shell 44 to accommodate fluid flow along the fluid flow path through the one or more support-shell side openings 52 to support-shell space 1067 (which is a sub-space of internal space 1054 of filter cartridge 1028), to a filtration-chamber outlet 1038.

Occluder 1080 is integrated into filter assembly 1032, typically permanently. For example, occluder may be coupled to a distal surface 1061 of handle 1062 (such as shown in FIG. 9), and/or to internal surface 1069 by one or more supports that allow fluid flow through support-shell space 1067 (configuration not shown).

In this configuration, filter 60 is typically coupled to external surface 78 of support-shell side wall 50 so as to cover the one or more support-shell side openings 52. This provides access to filter 60 when filter cartridge 1028 is at least partially immersed in liquid medium 13 contained in receptacle 24, such as described hereinabove with reference to FIG. 1. Thus, in this configuration, internal space 1054 of filter cartridge 1028 is typically defined by support shell 44.

Reference is now made to FIG. 10, which is a schematic illustration of a filter assembly 732, in accordance with an application of the present invention. Filter assembly 732 is an implementation of filter assembly 32, described hereinabove with reference to FIGS. 2A-B, and may implement any of the features thereof, mutatis mutandis. Any of the filter assemblies described herein may implement the features of filter assembly 732.

Filter assembly 732 comprises a handle 762, a filter cartridge 728, and a support shell 744, which are implementations of handle 62, filter cartridge 28, and support shell 44, respectively, described hereinabove with reference to FIGS. 2A-B, and may implement any of the features thereof, mutatis mutandis. Filter cartridge 728 further comprises filter 60. Optionally, any of the filter assemblies and/or filter cartridges described herein may implement the techniques of filter assembly 732 and/or filter cartridge 728, mutatis mutandis.

Support shell 744 of filter assembly 732 is elliptically cylindrical.

Optionally, handle 762 of filter assembly 732 is also elliptically cylindrical.

Reference is now made to FIGS. 11A-C which are schematic illustrations of a liquid-specimen-sample processing system 810, in accordance with an application of the present invention. Liquid-specimen-sample processing system 610 comprises a filter unit 820, which is an implementation of filter unit 20, described hereinabove with reference to FIGS. 2A-B, and may implement any of the features thereof, mutatis mutandis. Filter unit 820 comprises a filtration chamber 830 and a filter assembly 832. Filtration chamber 830 and filter assembly 832 are implementations of filtration chamber 30 and filter assembly 32, described hereinabove with reference to FIGS. 2A-B, and may implement any of the features thereof, mutatis mutandis. Liquid-specimen-sample processing system 610 may implement any of the features and comprise any of the elements of the other liquid-specimen-sample processing systems described herein, mutatis mutandis.

Filter assembly 832 is configurated to be partially inserted in filtration chamber 830, as shown in FIGS. 11A and 11C, and typically is entirely removable from filtration chamber 830 using a handle 862 of filter assembly 832, as shown in FIG. 11B.

Filter assembly 832 comprises handle 862, a filter cartridge 828, a support shell 844, and a filter 860, which are implementations of handle 62, filter cartridge 28, support shell 44, and filter 60, respectively, described hereinabove with reference to FIGS. 2A-B, and may implement any of the features thereof, mutatis mutandis. Support shell 844 has proximal and distal ends 846 and 848, and a support-shell side wall 850 that is shaped so as to define one or more support-shell side openings 852 therethrough to an internal space 854 defined by filter cartridge 828 (e.g., by filter 860).

Typically, filter 860 is coupled to an internal surface 875 of support-shell side wall 850 so as to cover the one or more support-shell side openings 852.

As shown in FIGS. 11A and 11C, filter assembly 832 is partially insertable into filtration chamber 830, such that (a) filter assembly 832 passes through and forms a fluid-tight seal with a filter-assembly opening 840 of filtration chamber 830, (b) handle 862 is disposed outside filtration chamber 830, and (c) filter cartridge 828 is disposed (typically, entirely) within filtration chamber 830 such that filter unit 820 defines:
a filtration-chamber space 864 within filtration chamber 830 between an inner surface 866 of a filtration-chamber wall 834 and filter cartridge 828 (e.g., between inner surface 866 and support-shell side wall 850 of support shell 844), and
a fluid flow path 868 that provides fluid communication in the following sequence: from a filtration-chamber inlet 836 (optionally, through distal end 848 of support shell 844), to internal space 854 of filter cartridge 828, through filter 860, through the one or more support-shell side openings 852, to filtration-chamber space 864, and to a filtration-chamber outlet 838.

For some applications, filtration chamber 830 comprises a volume-reduction shaft 806, as shown in FIGS. 11A and 11B. Volume-reduction shaft 806 is configured to fill at least 50% of a volume of internal space 854 of filter cartridge 828 when filter cartridge 828 is disposed within filtration chamber 830, such as at least 80%, e.g., at least 90%, such as at least 95%, of the volume of internal space 854 of filter cartridge 828. Typically, filter cartridge 828 passes through distal end 848 of support shell 844 when filter cartridge 828 is disposed within filtration chamber 830. For other applications, filtration chamber 830 does not comprise volume-reduction shaft 806, as shown in FIG. 11C. Alternatively, for some applications, filter assembly 832 comprises an occluder like occluder 1080, described hereinabove with reference to FIG. 9, mutatis mutandis.

For some applications, filter assembly 832 further comprises occluder 80, which is configured to selectively occlude at least 50% of a volume of internal space 854 of filter cartridge 828. For example, occluder 80 may implement any of the techniques described herein with reference to FIGS. 3A-B, 4A-B, 5A-C, 5D, 6A-B, 7A-B, and 8A-C, mutatis mutandis. In these applications, the occluder typically is configured to occlude no more than 99% (e.g., no more than 95%, such as no more than 90%, e.g., no more than 80%) of the volume of internal space 854 of filter cartridge 828 such that filter cartridge 828 defines a support-shell space between the occluder and an internal surface of support shell 844 to accommodate liquid medium 13 when filter cartridge 828 is inserted into receptacle 24, as described hereinabove with reference to FIG. 1, thereby facilitating contact between liquid medium 13 and filter 860. For some applications, the support-shell space between the occluder and the internal surface of support shell 844 has a volume of between 1 and 3 ml, similar to the amount of liquid medium 13 generally provided in conventional testing transport vials.

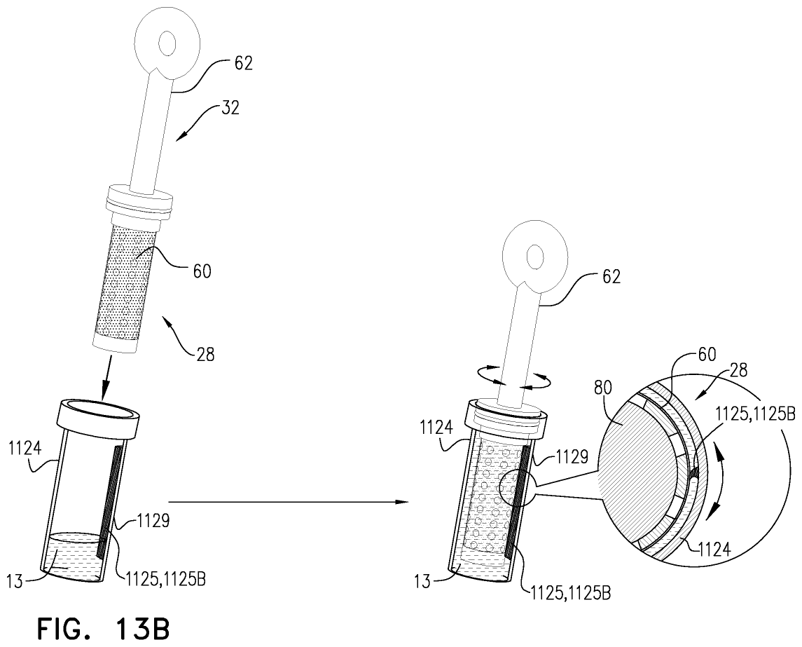

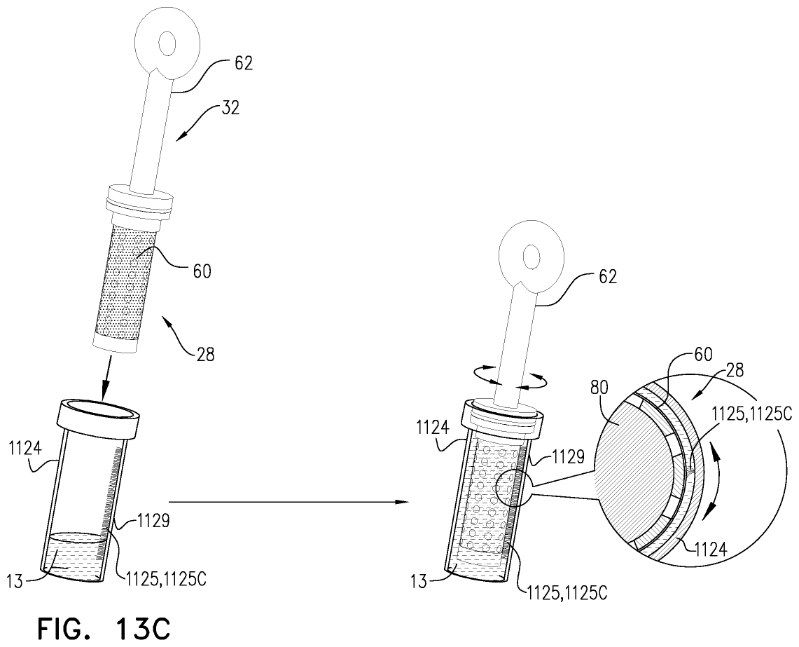

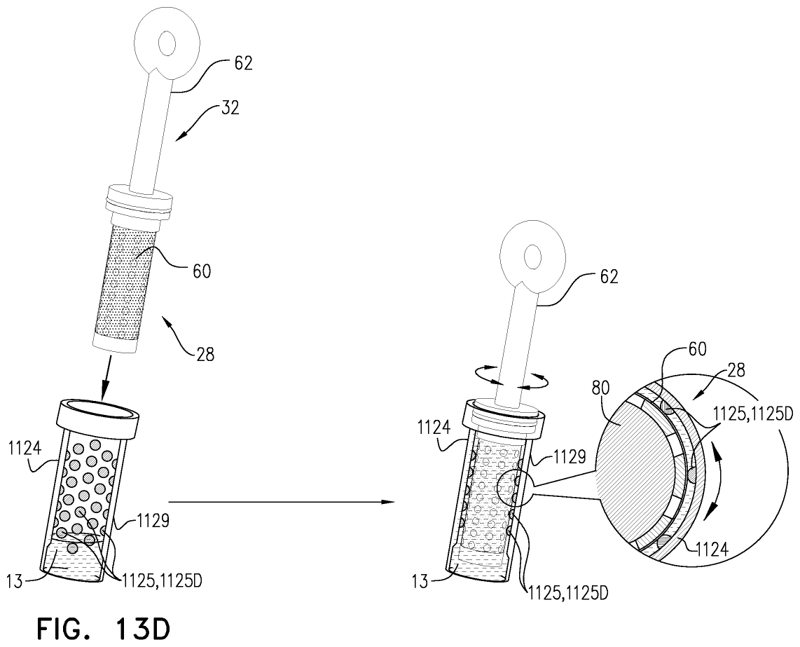

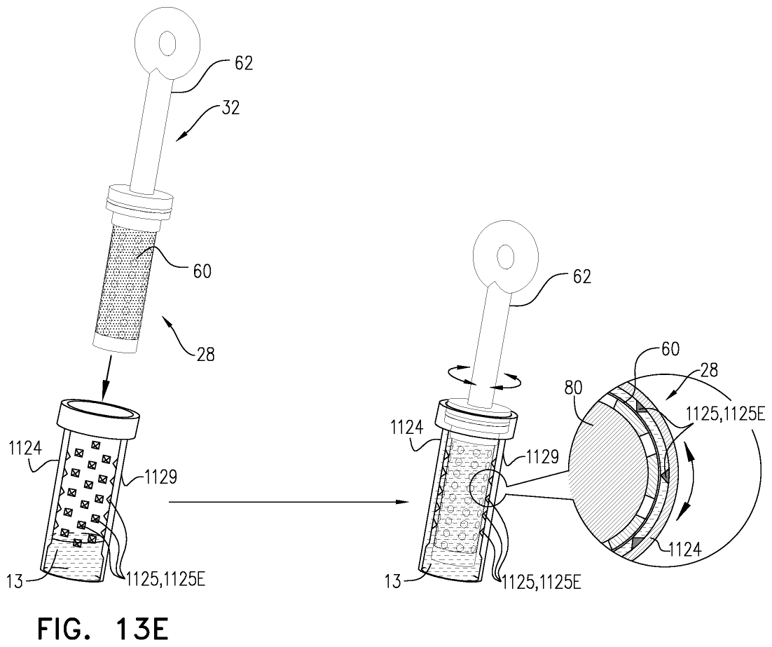

For some of these applications, an external surface of the occluder is shaped so as to define one or more protrusions, which are configured to physically disturb the filter, when the occluder occludes the volume of internal space 854 of filter cartridge 828, so as to help release, from the filter, biological particulate trapped by the filter, such as by cutting, tearing, macerating, scraping, and/or agitating the filter. The one or protrusions may implement any of the techniques described hereinbelow with reference to FIGS. 13A-E regarding the one or more protrusions 1125, mutatis mutandis. For example, the occluder may be configured to be rotatable with respect to internal space 854 so as to physically disturb the filter.

Reference is now made to FIG. 12, which is a schematic illustration of a portion of a liquid-specimen-sample processing system 910, in accordance with an application of the present invention. Liquid-specimen-sample processing system 910 may implement any of the techniques described hereinabove regarding liquid-specimen-sample processing systems 10, 510, 610, and/or 810, mutatis mutandis. Although liquid-specimen-sample processing system 910 is illustrated as comprising filter unit 20, described hereinabove with reference to FIGS. 1 and 2A-C, liquid-specimen-sample processing system 910 may alternatively comprise any of the other filter units described herein, including any combination of different configurations of these filter units.

Liquid-specimen-sample processing system 910 comprises a plurality of filter units arranged in series in a system fluid flow path. Although liquid-specimen-sample processing system 910 is illustrated as comprising exactly two filter units, the system may alternatively comprise a greater number of filter units, such as three, four, or more filter units.

In this configuration, filter unit 20 is a first filter unit 20, filtration chamber 30 is a first filtration chamber 30, filtration-chamber wall 34 is a first filtration-chamber wall 34, filtration-chamber inlet 36 is a first filtration-chamber inlet 36, filtration-chamber outlet 38 is a first filtration-chamber outlet 38, and filter-assembly opening 40 is a first filter-assembly opening 40, filter assembly 32 is a first filter assembly 32, filter cartridge 28 is a first filter cartridge 28, support shell 44 is a first support shell 44, support-shell side wall 50 is a first-support-shell side wall, filter 60 is a first filter 60, handle 62 is a first handle 62, and fluid flow path 68 is a first fluid flow path 68 (labeled in FIG. 2A).

Liquid-specimen-sample processing system 910 further comprises a second filter unit 920, which comprises a second filtration chamber 930, which comprises a second filtration-chamber wall 934 that is shaped so as to define a second filtration-chamber inlet 936, a second filtration-chamber outlet 938, and a second filter-assembly opening 940.

Second filter unit 920 further a second filter assembly 932, which comprises a second filter cartridge 928:
a second support shell 944, which has proximal and distal ends, and a second-support-shell side wall that is shaped so as to define one or more second-support-shell side openings therethrough to an internal space defined by second support shell 944; and
a second filter 960, which is coupled to the second-support-shell side wall so as to cover the one or more second-support-shell side openings.

Second filter assembly 932 further comprises a second handle 962, which is coupled to the proximal end of second support shell 944.

Second filter assembly 932 is partially insertable into second filtration chamber 930, such that (a) second filter assembly 932 passes through and forms a fluid-tight seal with second filter-assembly opening 940 of second filtration chamber 930, (b) second handle 962 is disposed outside second filtration chamber 930, and (c) second filter cartridge 928 is disposed within second filtration chamber 930 such that second filter unit 920 defines:
a second filtration-chamber space within second filtration chamber 930 between an inner surface of second filtration-chamber wall 934 and second filter cartridge 928, and
a second fluid flow path from second filtration-chamber inlet 936 to second filtration-chamber outlet 938, the second fluid flow path providing fluid communication among the second filtration-chamber space, the one or more second-support-shell side openings, and second filter 960.

Second filter 960 is configured to filter biological particulate from liquid specimen sample 22 when liquid specimen sample 22 is driven along the second fluid flow path while second filter cartridge 928 is disposed within second filtration chamber 930. Second filter assembly 932 is entirely removable from second filtration chamber 930 using second handle 962.

First filtration-chamber outlet 38 is in fluid communication with second filtration-chamber inlet 936, so as to define the above-mentioned system fluid flow path through the plurality of filter units 20, 920.

For some applications, after first and second filter assemblies 32 and 932 are entirely removed from first and second filtration chambers 30 and 930, respectively, and, optionally, first and second filter cartridges 28 and 928 (and, typically, all of filter assemblies 32 and 932) have been transported to a testing laboratory, the method further comprises testing for the presence of the biological particulate trapped by first and second filters 60 and 960. For example, first and second filters 60 and 960 (and, typically, first and second filter cartridges 28 and 928) may be placed in the same liquid medium 13.

For some applications:
first filter 90 has a first average absolute or nominal pore size, and is configured to mechanically filter the biological particulate from liquid specimen sample 22 by size-based filtration when liquid specimen sample 22 is driven along first fluid flow path 68 while first filter cartridge 28 is disposed within first filtration chamber 30,
second filter 960 has a second average absolute or nominal pore size, and is configured to mechanically filter the biological particulate from liquid specimen sample 22 by size-based filtration when liquid specimen sample 22 is driven along the second fluid flow path while second filter cartridge 928 is disposed within second filtration chamber 930, and
the second average absolute or nominal pore size is less than the first average absolute or nominal pore size.

For example, the second average absolute or nominal pore size may be less than 70% of the first average absolute or nominal pore size, such as less than 45% of the first average absolute or nominal pore size. For example, the first average absolute or nominal pore size may be between 0.2 and 2.0 microns, such as when filter 60 is used for capturing bacteria by size-based filtration. For example, such as when filter 960 is used for capturing free virus, virions, or viral particles by size-based filtration, the second average absolute or nominal pore size may be between 0.01 and 0.3 microns, and/or second filter 960 may have a molecular weight cut off of between 10 kDa and 500 kDa.

For some applications, first and second filters 60 and 960 are configured to filter first and second biological particulates from liquid specimen sample 22, the first and the second biological particulates of different types. For example, the different pore sizes mentioned above may provide this configuration. The method further comprises, after entirely removing first and second filter assemblies 32 and 932 from first and second filtration chambers 30 and 930, respectively, testing for the presence of the first and the second biological particulates trapped by first and second filters 60 and 960, respectively.

The first and the second biological particulates may comprise any pair of the biological particulates described hereinabove with reference to FIG. 1. For example, the first and the second biological particulates may be two categories of particulate, such as bacteria and a virus, or two different kinds of the same category of particulate, such as two different bacteria or two different viruses, optionally having different sizes or other different properties that allow them to be selectively filtered. For example, the first and the second particulates may be an Influenza virus and SARS-CoV-2, respectively.

In an application of the present invention, a liquid-specimen-sample processing system is provided that is similar to liquid-specimen-sample processing system 910, described hereinabove with reference to FIG. 12, other than as follows. The liquid-specimen-sample processing system comprises a plurality of filter units arranged in parallel, such that liquid specimen sample 22 is divided into a respective plurality of flow paths into and through the respective filter units. The liquid-specimen-sample processing system may implement any of the features of liquid-specimen-sample processing system 910, mutatis mutandis.

Reference is now made to FIGS. 13A-E, which are schematic illustrations of the partial insertion of filter assembly 32 into a receptacle 1124, in accordance with respective applications of the present invention. Receptacle 1124 is an implementation of receptacle 24, described hereinabove with reference to FIG. 1, and typically contains liquid medium 13. Although FIGS. 13A-E illustrate the partial insertion of filter assembly 32 into receptacle 1124, the other filter assemblies described herein may also be inserted into receptacle 1124, mutatis mutandis. In addition, receptacle 524, described hereinabove with reference to FIGS. 7A-B, may optionally implement the features of receptacle 1124, mutatis mutandis. Although filter assembly 32 is shown in FIGS. 13A-E as comprising occluder 80, alternatively filter assembly 32 may not comprise an occluder.

An inner surface of a side wall of receptacle 1124 is shaped so as to define one or more protrusions 1125, which are configured to physically disturb filter 60, when filter assembly 32 is as least partially within receptacle 1124, so as to help release, from filter 60, biological particulate trapped by filter 60, such as by cutting, tearing, macerating, scraping, and/or agitating filter 60. This improved release of the biological particulate may provide higher sensitivity in the subsequent testing for the biological particulate, as described hereinabove with reference to FIG. 1. (For example, the biological particulate may be entrapped, absorbed, and/or otherwise captured on the surface of and/or within the filter, depending on the thickness and properties of the filter.) For example, the one or more protrusions 1125 may be shaped to physically disturb filter 60 as filter assembly 32 is advanced into receptacle 1124, moved forward and backward within receptacle 1124, and/or rotated within receptacle 1124.

For applications in which receptacle 1124 contains liquid medium 13, the one or more protrusions 1125 are shaped so as to physically disturb filter 60 while still allowing contact of liquid medium 13 with filter 60, such that the released biological particulate is released into liquid medium 13 for subsequent testing.

For example, the one or more protrusions 1125 may be shaped as:
one or more ridges, such as one or more protruding screw threads 1125A, such as shown in FIG. 13A, and/or one or more elongate straight ridges 1125B, such as shown in FIG. 13B.
bristles 1125C, such as shown in FIG. 13C, e.g., arranged in one or more lines, or scattered,
bumps 1125D, such as shown in FIG. 13D, e.g., arranged in one or more lines, or scattered,
spikes 1125E, such as shown in FIG. 13E, e.g., arranged in one or more lines, or scattered, and/or
a combination of two or more of these shapes.

Any of the one or more protrusions 1125 (except bumps 1125D) may optionally be sharp, so as to serve as blades that cut the filter. In configurations in which a mesh is provided that surrounds the filter, the one or more protrusions 1125 are typically sharp enough to cut through the mesh and physically disturb the filter.

Optionally, the one or more protrusions 1125 are arranged in one or more lines that are oriented parallel to central longitudinal axis of receptacle 1124, or at a relatively small offset to parallel (e.g., less than 30 degrees, such as less than 15 degrees from parallel).

For some applications, the one or more protrusions 1125 are integral with side wall 1129 of receptacle 1124 (e.g., manufactured as a single piece, such as by molding). For other applications, the one or more protrusions 1125 are separate elements that are attached to side wall 1129 of receptacle 1124; for example, the one or more protrusions 1125 may comprise a softer material than side wall 1129, such as silicone or rubber.

In this configuration, filter 60 is typically coupled to external surface 78 of support-shell side wall 50 so as to cover the one or more support-shell side openings 52, and allow direct physical contact between the one or more protrusions 1125 and filter 60.

Although filter cartridge 28 is shown in FIGS. 13A-E as comprising a single filter 60, filter cartridge 28 may alternatively comprise a plurality of layered filters 60, such as described hereinabove with reference to FIGS. 2A-C; in this case, the one or more protrusions 1125 are configured to physically disturb one or more of filters 60, such as all of filters 60.

In an embodiment, the techniques and apparatus described herein are combined with techniques and apparatus described in one or more of the following patent applications, which are assigned to the assignee of the present application and are incorporated herein by reference:
PCT Publication WO 2018/158768 to Fruchter et al., and US Patent Application Publication 2019/0381498 in the US national stage thereof;
U.S. Provisional Application 62/727,208, filed Sep. 5, 2018;
U.S. Provisional Application 62/727,268, filed Sep. 5, 2018;
PCT Publication WO 2020/049566 to Fruchter et al.;
PCT Publication WO 2020/049569 to Fruchter et al., and US Patent Application Publication 2021/0215585 in the US national stage thereof;
U.S. Provisional Application 62/896,295, filed Sep. 5, 2019;
U.S. Provisional Application 62/988,145, filed Mar. 11, 2020;
U.S. Provisional Application 62/988,259, filed Mar. 11, 2020;
U.S. Provisional Application 63/020,723, filed May 6, 2020; U.S. Provisional Application 63/037,707, filed Jun. 11, 2020; U.S. Provisional Application 63/067,535, filed Aug. 19, 2020; U.S. Provisional Application 63/117,294, filed Nov. 23, 2020; U.S. Provisional Application 63/156,843, filed Mar. 4, 2021; U.S. Provisional Application 63/158,005, filed Mar. 8, 2021; U.S. Provisional Application 63/166,378, filed Mar. 26, 2021; and U.S. Provisional Application 63/176,565, filed Apr. 19, 2021;
International Application PCT/IL2021/050519, filed May 6, 2021;
PCT Publication WO 2021/044417 to Holtz et al.;
International Application PCT/IB2021/052055, filed Mar. 11, 2021;
International Application PCT/IB2021/052056, filed Mar. 11, 2021; and/or
U.S. Provisional Application 63/071,529, filed Aug. 28, 2020.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A filter unit for filtering a liquid specimen sample, the filter unit comprising:
a filtration chamber, which comprises a filtration-chamber wall that is shaped so as to define a filtration-chamber inlet, a filtration-chamber outlet, and a filter-assembly opening; and
a filter assembly, which comprises:
(a) a filter cartridge, which comprises:
(i) a support shell, which has proximal and distal ends, and a support-shell side wall that is shaped so as to define one or more support-shell side openings therethrough to an internal space defined by the filter cartridge; and
(ii) a filter, which is coupled to the support-shell side wall so as to cover the one or more support-shell side openings; and
(b) a handle, which is coupled to the proximal end of the support shell,
wherein the filter assembly is partially insertable into the filtration chamber, such that (a) the filter assembly passes through and forms a fluid-tight seal with the filter-assembly opening of the filtration chamber, (b) the handle is disposed outside the filtration chamber, and (c) the filter cartridge is disposed within the filtration chamber such that the filter unit defines:
a filtration-chamber space within the filtration chamber between an inner surface of the filtration-chamber wall and the filter cartridge, and
a fluid flow path from the filtration-chamber inlet to the filtration-chamber outlet, the fluid flow path providing fluid communication among the filtration-chamber space, the one or more support-shell side openings, and the filter,
wherein the filter is configured to filter biological particulate from the liquid specimen sample when the liquid specimen sample is driven along the fluid flow path while the filter cartridge is disposed within the filtration chamber, and
wherein the filter assembly is entirely removable from the filtration chamber using the handle.

2. The filter unit according to claim 1, wherein the filter is configured to mechanically filter the biological particulate from the liquid specimen sample by size-based filtration when the liquid specimen sample is driven along the fluid flow path while the filter cartridge is disposed within the filtration chamber.

3. The filter unit according to claim 1, wherein the filter unit is configured such that when the filter cartridge is disposed within the filtration chamber, the filtration-chamber space entirely surrounds the support-shell side wall.

4. The filter unit according to claim 1, wherein the filter entirely surrounds the support-shell side wall.

5. The filter unit according to claim 1, wherein the filter is tubular.

6. The filter unit according to claim 1, wherein the support shell is tubular.

7. The filter unit according to claim 6, wherein the support shell is circularly cylindrical.

8. The filter unit according to claim 6, wherein the support shell is elliptically cylindrical.

9. The filter unit according to claim 6, wherein the support shell is rectangular.

10. The filter unit according to claim 1, wherein the filter has an average thickness of between 20 microns and 2 mm.

11. The filter unit according to claim 1, wherein the filter has a surface area of between 5 and 20 cm2.

12. The filter unit according to claim 1, further comprising a motor that is configured to agitate the filter cartridge when the filter cartridge is disposed within the filtration chamber.

13. The filter unit according to any one of claims 1-12, wherein the filter-assembly opening passes through a proximal end of the filtration-chamber wall, and wherein the filtration-chamber outlet passes through a distal end of the filtration-chamber wall.

14. The filter unit according to claim 13, wherein the filtration-chamber inlet passes through a side portion of the filtration-chamber wall.

15. The filter unit according to any one of claims 1-12, wherein the filter is coupled to an external surface of the support-shell side wall so as to cover the one or more support-shell side openings.

16. The filter unit according to claim 15, wherein the filter unit is configured such that when the filter cartridge is disposed within the filtration chamber, the fluid flow path provides the fluid communication in the following sequence: from the filtration-chamber inlet, to the filtration-chamber space, through the filter, through the one or more support-shell side openings to the internal space of the filter cartridge, and to the filtration-chamber outlet.

17. The filter unit according to claim 16, wherein the filter unit is configured such that when the filter cartridge is disposed within the filtration chamber, the fluid flow path provides the fluid communication in the following sequence: from the filtration-chamber inlet, to the filtration-chamber space, through the filter, through the one or more support-shell side openings to the internal space of the filter cartridge, through the distal end of the support shell, and to the filtration-chamber outlet.

18. A liquid-specimen-sample processing system comprising the filter unit according to claim 15, the liquid-specimen-sample processing system further comprising a receptacle, wherein the filter assembly and the receptacle are configured such that the filter assembly is partially insertable into the receptacle using the handle, such that at least a portion of the handle is outside the receptacle and at least a portion of the filter cartridge is disposed within the receptacle.

19. The liquid-specimen-sample processing system according to claim 18, wherein an inner surface of a side wall of the receptacle is shaped so as to define one or more protrusions, which are configured to physically disturb the filter, when the filter assembly is as least partially within the receptacle, so as to help release, from the filter, the biological particulate trapped by the filter.

20. The liquid-specimen-sample processing system according to claim 19, wherein the one or more protrusions are configured to cut, tear, or macerate the filter.

21. The liquid-specimen-sample processing system according to claim 19, wherein the one or more protrusions are configured to scrape the filter.

22. The liquid-specimen-sample processing system according to claim 19, wherein the one or more protrusions are configured to agitate the filter.

23. The liquid-specimen-sample processing system according to claim 19, wherein the receptacle contains a liquid medium, and wherein the one or more protrusions are configured to physically disturb the filter, while still allowing contact of the liquid medium with the filter, such that the released biological particulate is released into the liquid medium for subsequent testing.

24. The liquid-specimen-sample processing system according to claim 19, wherein the one or more protrusions are configured to physically disturb the filter upon rotation of the filter assembly while within the receptacle.

25. The liquid-specimen-sample processing system according to claim 19, wherein the one or more protrusions are shaped as one or more of the shapes selected from the group consisting of: one or more ridges, bristles, spikes, and bumps.

26. The filter unit according to any one of claims 1-12, wherein the filter is coupled to an internal surface of the support-shell side wall so as to cover the one or more support-shell side openings.

27. The filter unit according to claim 26, wherein the filter unit is configured such that when the filter cartridge is disposed within the filtration chamber, the fluid flow path provides the fluid communication in the following sequence: from the filtration-chamber inlet, to the internal space of the filter cartridge, through the filter, through the one or more support-shell openings, to the filtration-chamber space, and to the filtration-chamber outlet.

28. The filter unit according to claim 26, wherein the filter assembly further comprises an occluder, which is configured to selectively occlude at least 50% of a volume of the internal space of the filter cartridge.

29. The filter unit according to claim 26, wherein the filtration chamber comprises a volume-reduction shaft, which is configured to fill at least 50% of a volume of the internal space of the filter cartridge when the filter cartridge is disposed within the filtration chamber.

30. The filter unit according to claim 29, wherein the filter assembly further comprises an occluder, which is configured to selectively occlude between 50% and 99% of a volume of the internal space of the filter cartridge.

31. The filter unit according to any one of claims 1-12, wherein the filter assembly further comprises an occluder, which is configured to selectively occlude at least 50% of a volume of the internal space of the filter cartridge.

32. The filter unit according to claim 31, wherein the occluder is configured to selectively occlude at least 80% of the volume of the internal space of the filter cartridge.

33. The filter unit according to claim 32, wherein the occluder is configured to selectively occlude at least 90% of the volume of the internal space of the filter cartridge.

34. The filter unit according to claim 31, wherein the occluder is configured to selectively occlude at least 50% of a volume of the internal space by selectively occupying at least 50% of the volume of the internal space.

35. The filter unit according to claim 31, wherein the occluder is integrated into the filter assembly, and is configured to selectively assume (a) a non-occluding configuration, in which the occluder does not occlude at least 50% of the volume of the internal space, and (b) an occluding configuration, in which the occluder occludes at least 50% of the volume of the internal space.

36. The filter unit according to claim 35, wherein the handle is coupled to the occluder, such that movement of the handle with respect to the support shell transitions the occluder from the non-occluding configuration to the occluding configuration.

37. The filter unit according to claim 31, wherein the occluder comprises a tubular shaft, which is configured to be disposable:
at least partially outside the internal space of the filter cartridge when in a non-occluding configuration, in which the tubular shaft does not occlude at least 50% of the volume of the internal space, and
at least partially within the internal space of the filter cartridge when in an occluding configuration, in which the tubular shaft occludes at least 50% of the volume of the internal space.

38. The filter unit according to claim 37, wherein the tubular shaft is slidable with respect to the internal space of the filter cartridge.

39. The filter unit according to claim 37, wherein the tubular shaft is moveable with respect to a radially-outer portion of the handle and the internal space of the filter cartridge, and wherein the tubular shaft:
when in the non-occluding configuration, is disposed at least partially within the radially-outer portion of the handle outside the internal space of the filter cartridge, and
when in the occluding configuration, is disposed at least partially outside the radially-outer portion of the handle within the internal space of the filter cartridge.

40. The filter unit according to claim 37, wherein a portion of the handle is shaped so as to define the tubular shaft.

41. The filter unit according to claim 37, wherein the tubular shaft is coupled to a distal end of the handle.

42. The filter unit according to claim 35,
wherein the occluder comprises an occluder shell, which has proximal and distal ends, and an occluder-shell side wall that is shaped so as to define one or more occluder-shell side openings therethrough to an internal space defined by the occluder shell,
wherein the occluder shell is disposed within the support shell, and rotatable with respect to the support shell to set an alignment of the one or more occluder-shell side openings with the one or more support-shell side openings, and
wherein the occluder is configured to selectively assume:
the non-occluding configuration when the one or more occluder-shell side openings are aligned with the one or more support-shell side openings, and
the occluding configuration when the one or more occluder-shell side openings are not aligned with the one or more support-shell side openings.

43. The filter unit according to claim 42, wherein the handle is coupled to the occluder shell, such that rotation of the handle with respect to the support shell rotates the occluder shell with respect to the support shell.

44. The filter unit according to claim 42,
wherein the distal end of the support shell is shaped so as to define a support-shell distal outlet, which, when open, is in fluid communication with the filtration-chamber outlet when the filter cartridge is disposed within the filtration chamber, and
wherein the filter assembly is configured such that:
when the occluder is in the non-occluding configuration, the support-shell distal outlet is open, and
when the occluder is in the occluding configuration, the support-shell distal outlet is blocked and thus closed.

45. The filter unit according to claim 44,
wherein the support shell is shaped so as to further define, at the distal end thereof, and a support-shell distal wall that is shaped so as to define one or more support-shell distal openings therethrough to the internal space defined by the filter cartridge,
wherein the occluder shell is shaped so as to further to define, at the distal end thereof, an occluder-shell distal wall that is shaped so as to define one or more occluder-shell distal openings therethrough to the internal space defined by the occluder shell,
wherein the occluder shell is rotatable with respect to the support shell to set the alignment of the one or more occluder-shell side openings with the one or more support-shell side openings, and an alignment of the one or more occluder-shell distal openings with the one or more support-shell distal openings,
wherein the occluder is configured to selectively assume:
the non-occluding configuration when the one or more occluder-shell side openings are aligned with the one or more support-shell side openings, and the one or more occluder-shell distal openings are aligned with the one or more support-shell distal openings, and
the occluding configuration when the one or more occluder-shell side openings are not aligned with the one or more support-shell side openings, and the one or more occluder-shell distal openings are not aligned with the one or more support-shell distal openings.

46. The filter unit according to claim 44, wherein the occluder further comprises a pressure-activated valve in fluid communication with the distal end of the support shell.

47. The filter unit according to claim 31, wherein the filter is coupled to an external surface of the support-shell side wall so as to cover the one or more support-shell side openings.

48. The filter unit according to claim 31, wherein the filter is coupled to an internal surface of the support-shell side wall so as to cover the one or more support-shell side openings.

49. The filter unit according to any one of claims 1-12, wherein the filter assembly further comprises an occluder, which is configured to permanently occlude at least 50% and no more than 99% of a volume of the internal space of the filter cartridge.

50. The filter unit according to claim 49, wherein the occluder is coupled to a distal surface of the handle.

51. The filter unit according to claim 49, wherein the filter is coupled to an external surface of the support-shell side wall so as to cover the one or more support-shell side openings.

52. A liquid-specimen-sample processing system comprising the filter unit according to any one of claims 1-12, the liquid-specimen-sample processing system further comprising a fluid-pressure source, which is arranged to apply pressure to drive the liquid specimen sample along the fluid flow path.

53. The liquid-specimen-sample processing system according to claim 52, wherein the fluid-pressure source is configured to pump gas into the filtration-chamber inlet to complete the driving of the liquid specimen sample into the filtration-chamber inlet.

54. A liquid-specimen-sample processing system comprising the filter unit according to any one of claims 1-12, the liquid-specimen-sample processing system further comprising:
a receptacle configured to receive the filter cartridge; and
an occluder, which is configured to selectively occlude at least 50% of a volume of the internal space of the filter cartridge, and which comprises a tubular shaft disposed within the receptacle, protruding upward from a floor of the receptacle, and
wherein the tubular shaft is configured to be disposable:
at least partially outside the internal space of the filter cartridge when in a non-occluding configuration, in which the tubular shaft does not occlude at least 50% of the volume of the internal space, and
at least partially within the internal space of the filter cartridge when in an occluding configuration, in which the tubular shaft occludes at least 50% of the volume of the internal space.

55. A liquid-specimen-sample processing system comprising the filter unit according to any one of claims 1-12,
wherein the filter unit is a first filter unit, the filtration chamber is a first filtration chamber, the filtration-chamber wall is a first filtration-chamber wall, the filtration-chamber inlet is a first filtration-chamber inlet, the filtration-chamber outlet is a first filtration-chamber outlet, the filter-assembly opening is a first filter-assembly opening, the filter assembly is a first filter assembly, the filter cartridge is a first filter cartridge, the support shell is a first support shell, the support-shell side wall is a first-support-shell side wall, the filter is a first filter, the handle is a first handle, and the fluid flow path is a first fluid flow path,
wherein the liquid-specimen-sample processing system further comprises a second filter unit, which comprises:
a second filtration chamber, which comprises a second filtration-chamber wall that is shaped so as to define a second filtration-chamber inlet, a second filtration-chamber outlet, and a second filter-assembly opening; and
a second filter assembly, which comprises:
(a) a second filter cartridge, which comprises:
(i) a second support shell, which has proximal and distal ends, and a second-support-shell side wall that is shaped so as to define one or more second-support-shell side openings therethrough to an internal space defined by the second support shell; and
(ii) a second filter, which is coupled to the second-support-shell side wall so as to cover the one or more second-support-shell side openings; and
(b) a second handle, which is coupled to the proximal end of the second support shell,
wherein the second filter assembly is partially insertable into the second filtration chamber, such that (a) the second filter assembly passes through and forms a fluid-tight seal with the second filter-assembly opening of the second filtration chamber, (b) the second handle is disposed outside the second filtration chamber, and (c) the second filter cartridge is disposed within the second filtration chamber such that the second filter unit defines:
a second filtration-chamber space within the second filtration chamber between an inner surface of the second filtration-chamber wall and the second filter cartridge, and
a second fluid flow path from the second filtration-chamber inlet to the second filtration-chamber outlet, the second fluid flow path providing fluid communication among the second filtration-chamber space, the one or more second-support-shell side openings, and the second filter,
wherein the second filter is configured to filter biological particulate from the liquid specimen sample when the liquid specimen sample is driven along the second fluid flow path while the second filter cartridge is disposed within the second filtration chamber, and
wherein the second filter assembly is entirely removable from the second filtration chamber using the second handle, and
wherein first filtration-chamber outlet is in fluid communication with the second filtration-chamber inlet.

56. The liquid-specimen-sample processing system according to claim 55,
wherein the first filter has a first average absolute pore size, and is configured to mechanically filter the biological particulate from the liquid specimen sample by size-based filtration when the liquid specimen sample is driven along the first fluid flow path while the first filter cartridge is disposed within the first filtration chamber,
wherein the second filter has a second average absolute pore size, and is configured to mechanically filter the biological particulate from the liquid specimen sample by size-based filtration when the liquid specimen sample is driven along the second fluid flow path while the second filter cartridge is disposed within the second filtration chamber, and
wherein the second average absolute pore size is less than the first average absolute pore size.

57. The liquid-specimen-sample processing system according to claim 55,
wherein the first filter has a first average nominal pore size, and is configured to mechanically filter the biological particulate from the liquid specimen sample by size-based filtration when the liquid specimen sample is driven along the first fluid flow path while the first filter cartridge is disposed within the first filtration chamber,
wherein the second filter has a second average nominal pore size, and is configured to mechanically filter the biological particulate from the liquid specimen sample by size-based filtration when the liquid specimen sample is driven along the second fluid flow path while the second filter cartridge is disposed within the second filtration chamber, and
wherein the second average nominal pore size is less than the first average nominal pore size.

58. A liquid-specimen-sample processing system comprising the filter unit according to any one of claims 1-12, the liquid-specimen-sample processing system further comprising a waste liquid receptacle, which is coupled to filtration chamber in fluid communication with the filtration-chamber outlet.

59. The liquid-specimen-sample processing system according to claim 58, wherein the waste liquid receptacle is shaped so as to define an opening through an external wall of the waste liquid receptacle, and wherein the waste liquid receptacle comprises an air filter that is disposed to filter air that passes out of the waste liquid receptacle through the opening.

60. A filter assembly for filtering a liquid specimen sample, the filter assembly comprising:
a filter cartridge, which comprises:
(a) a support shell, which has proximal and distal ends, and a support-shell side wall that is shaped so as to define one or more support-shell side openings therethrough to an internal space defined by the filter cartridge; and
(b) a filter, which is coupled to the support-shell side wall so as to cover the one or more support-shell side openings, and which is configured to filter biological particulate from the liquid specimen sample when the liquid specimen sample is driven through the filter and the one or more support-shell side openings;
a handle, which is coupled to the proximal end of the support shell; and
an occluder, which is configured to selectively occlude at least 50% of a volume of the internal space of the filter cartridge.

61. The filter assembly according to claim 60, wherein the filter has an average thickness of between 20 microns and 2 mm.

62. The filter assembly according to claim 60, wherein the filter has a surface area of between 5 and 20 cm2.

63. The filter assembly according to claim 60, wherein the occluder is configured to selectively occlude at least 80% of the volume of the internal space of the filter cartridge.

64. The filter assembly according to claim 63, wherein the occluder is configured to selectively occlude at least 90% of the volume of the internal space of the filter cartridge.

65. The filter assembly according to claim 60, wherein the occluder is configured to selectively occlude at least 50% of a volume of the internal space by selectively occupying at least 50% of the volume of the internal space.

66. The filter assembly according to any one of claims 60-65, wherein the filter is coupled to an internal surface of the support-shell side wall so as to cover the one or more support-shell side openings.

67. The filter assembly according to any one of claims 60-65, wherein the filter is coupled to an external surface of the support-shell side wall so as to cover the one or more support-shell side openings.

68. A liquid-specimen-sample processing system comprising the filter assembly according to claim 67, the liquid-specimen-sample processing system further comprising a receptacle, wherein the filter assembly and the receptacle are configured such that the filter assembly is partially insertable into the receptacle using the handle, such that at least a portion of the handle is outside the receptacle and at least a portion of the filter cartridge is disposed within the receptacle.

69. The liquid-specimen-sample processing system according to claim 68, wherein an inner surface of a side wall of the receptacle is shaped so as to define one or more protrusions, which are configured to physically disturb the filter, when the filter assembly is as least partially within the receptacle, so as to help release, from the filter, the biological particulate trapped by the filter.

70. The liquid-specimen-sample processing system according to claim 69, wherein the one or more protrusions are configured to cut, tear, or macerate the filter.

71. The liquid-specimen-sample processing system according to claim 69, wherein the one or more protrusions are configured to scrape the filter.

72. The liquid-specimen-sample processing system according to claim 69, wherein the one or more protrusions are configured to agitate the filter.

73. The liquid-specimen-sample processing system according to claim 69, wherein the receptacle contains a liquid medium, and wherein the one or more protrusions are configured to physically disturb the filter, while still allowing contact of the liquid medium with the filter, such that the released biological particulate is released into the liquid medium for subsequent testing.

74. The liquid-specimen-sample processing system according to claim 69, wherein the one or more protrusions are configured to physically disturb the filter upon rotation of the filter assembly while within the receptacle.

75. The liquid-specimen-sample processing system according to claim 69, wherein the one or more protrusions are shaped as one or more of the shapes selected from the group consisting of: one or more ridges, bristles, spikes, and bumps.

76. The filter assembly according to any one of claims 60-65, wherein the occluder is integrated into the filter assembly, and is configured to selectively assume (a) a non-occluding configuration, in which the occluder does not occlude at least 50% of the volume of the internal space, and (b) an occluding configuration, in which the occluder occludes at least 50% of the volume of the internal space.

77. The filter assembly according to claim 76, wherein the handle is coupled to the occluder, such that movement of the handle with respect to the support shell transitions the occluder from the non-occluding configuration to the occluding configuration.

78. The filter assembly according to any one of claims 60-652, wherein the occluder comprises a tubular shaft, which is configured to be disposable:
at least partially outside the internal space of the filter cartridge when in a non-occluding configuration, in which the tubular shaft does not occlude at least 50% of the volume of the internal space, and
at least partially within the internal space of the filter cartridge when in an occluding configuration, in which the tubular shaft occludes at least 50% of the volume of the internal space.

79. The filter assembly according to claim 78, wherein the tubular shaft is slidable with respect to the internal space of the filter cartridge.

80. The filter assembly according to claim 78, wherein the tubular shaft is moveable with respect to a radially-outer portion of the handle and the internal space of the filter cartridge, and wherein the tubular shaft:
when in the non-occluding configuration, is disposed at least partially within the radially-outer portion of the handle outside the internal space of the filter cartridge, and
when in the occluding configuration, is disposed at least partially outside the radially-outer portion of the handle within the internal space of the filter cartridge.

81. The filter assembly according to claim 78, wherein a portion of the handle is shaped so as to define the tubular shaft.

82. The filter assembly according to claim 78, wherein the tubular shaft is coupled to a distal end of the handle.

83. The filter assembly according to claim 76,
wherein the oceluder comprises an oceluder shell, which has proximal and distal ends, and an oceluder-shell side wall that is shaped so as to define one or more oceluder-shell side openings therethrough to an internal space defined by the occluder shell,
wherein the occluder shell is disposed within the support shell, and rotatable with respect to the support shell to set an alignment of the one or more occluder-shell side openings with the one or more support-shell side openings, and
wherein the occluder is configured to selectively assume:
the non-occluding configuration when the one or more occluder-shell side openings are aligned with the one or more support-shell side openings, and
the occluding configuration when the one or more occluder-shell side openings are not aligned with the one or more support-shell side openings.

84. The filter assembly according to claim 83, wherein the handle is coupled to the occluder shell, such that rotation of the handle with respect to the support shell rotates the occluder shell with respect to the support shell.

85. The filter assembly according to claim 83,
wherein the distal end of the support shell is shaped so as to define a support-shell distal outlet, and
wherein the filter assembly is configured such that:
when the occluder is in the non-occluding configuration, the support-shell distal outlet is open, and
when the occluder is in the occluding configuration, the support-shell distal outlet is blocked and thus closed.

86. The filter assembly according to claim 85,
wherein the support shell is shaped so as to further define, at the distal end thereof, and a support-shell distal wall that is shaped so as to define one or more support-shell distal openings therethrough to the internal space defined by the filter cartridge,
wherein the occluder shell is shaped so as to further to define, at the distal end thereof, an occluder-shell distal wall that is shaped so as to define one or more occluder-shell distal openings therethrough to the internal space defined by the occluder shell,
wherein the occluder shell is rotatable with respect to the support shell to set the alignment of the one or more occluder-shell side openings with the one or more support-shell side openings, and an alignment of the one or more oceluder-shell distal openings with the one or more support-shell distal openings,
wherein the oceluder is configured to selectively assume:
the non-occluding configuration when the one or more occluder-shell side openings are aligned with the one or more support-shell side openings, and the one or more occluder-shell distal openings are aligned with the one or more support-shell distal openings, and
the occluding configuration when the one or more occluder-shell side openings are not aligned with the one or more support-shell side openings, and the one or more occluder-shell distal openings are not aligned with the one or more support-shell distal openings.

87. The filter assembly according to claim 85, wherein the occluder further comprises a pressure-activated valve in fluid communication with the distal end of the support shell.

88. A method comprising:
driving a liquid specimen sample into a filtration-chamber inlet defined by a filtration-chamber wall of a filtration chamber of a filter unit, the filter unit further including a filter assembly, which includes: (a) a filter cartridge, which includes: (i) a support shell, which has proximal and distal ends, and a support-shell side wall that is shaped so as to define one or more support-shell side openings therethrough to an internal space defined by the filter cartridge; and (ii) a filter, which is coupled to the support-shell side wall so as to cover the one or more support-shell side openings; and (b) a handle, which is coupled to the proximal end of the support shell,
wherein driving comprises driving the liquid specimen sample into the filtration-chamber inlet while the filter assembly is partially inserted into the filtration chamber, such that (a) the filter assembly passes through and forms a fluid-tight seal with a filter-assembly opening defined by the filtration-chamber wall, (b) the handle is disposed outside the filtration chamber, and (c) the filter cartridge is disposed within the filtration chamber such that the filter unit defines: (i) a filtration-chamber space within the filtration chamber between an inner surface of the filtration-chamber wall and the filter cartridge, and (ii) a fluid flow path from the filtration-chamber inlet to a filtration-chamber outlet defined by the filtration-chamber wall, the fluid flow path providing fluid communication among the filtration-chamber space, the one or more support-shell side openings, and the filter, wherein the filter is configured to filter biological particulate from the liquid specimen sample when the liquid specimen sample is driven along the fluid flow path while the filter cartridge is disposed within the filtration chamber; and
after finishing driving the liquid specimen sample into the filtration-chamber inlet, entirely removing the filter assembly from the filtration chamber using the handle.

89. The method according to claim 88, wherein entirely removing the filter assembly from the filtration chamber using the handle comprises entirely removing the filter assembly from the filtration chamber using only the handle, without otherwise touching the filter.

90. The method according to claim 88, further comprising, after entirely removing the filter assembly from the filtration chamber, testing for the presence of the biological particulate trapped by the filter.

91. The method according to claim 90, wherein testing for the presence of the biological particulate comprises inserting the filter cartridge into a testing machine.

92. The method according to claim 90, wherein testing for the presence of the biological particulate comprises inserting the filter cartridge into a liquid medium.

93. The method according to claim 92, wherein testing for the presence of the biological particulate comprises agitating the filter cartridge in the liquid medium.

94. The method according to claim 93, wherein agitating the filter cartridge in the liquid medium comprises mixing the filter cartridge in the liquid medium.

95. The method according to claim 92, wherein testing for the presence of the biological particulate comprises transferring at least a portion of the liquid medium into a testing machine.

96. The method according to claim 92, wherein the liquid medium is selected from the group consisting of: a transport medium, a culture medium, a purification agent, a stabilizing agent, a lysing buffer, and an extraction agent.

97. The method according to claim 91, wherein the testing machine is selected from the group consisting of: a thermal cycler and an isothermal amplification instrument.

98. The method according to claim 90, further comprising, after entirely removing the filter assembly from the filtration chamber and before testing for the presence of the biological particulate, transporting the filter assembly while the filter is at least partially immersed in a liquid medium.

99. The method according to claim 98, wherein testing for the presence of the biological particulate comprises inserting at least a portion of the liquid medium into a thermal cycler.

100. The method according to claim 98, wherein testing for the presence of the biological particulate comprises agitating the filter in the liquid medium.

101. The method according to claim 98, wherein the liquid medium is selected from the group consisting of: a transport medium, a culture medium, a purification agent, a stabilizing agent, a lysing buffer, and an extraction agent.

102. The method according to claim 90, wherein testing for the presence of the biological particulate comprises incubating the filter in a growth medium.

103. The method according to claim 88, wherein the liquid specimen sample is a non-centrifuged liquid specimen sample, and wherein driving comprises driving the non-centrifuged liquid specimen sample into the filtration-chamber inlet.

104. The method according to claim 88, wherein driving the liquid specimen sample into the filtration-chamber inlet comprising pumping gas into the filtration-chamber inlet to complete the driving of the liquid specimen sample into the filtration-chamber inlet.

105. The method according to claim 88, further comprising agitating the filter cartridge while the filter cartridge is disposed within the filtration chamber.

106. The method according to claim 88, further comprising agitating the filter cartridge after entirely removing the filter assembly from the filtration chamber.

107. The method according to 106, further comprising agitating the filter cartridge after the filter assembly has been inserted into a liquid medium.

108. The method according to claim 88,
wherein the filter assembly further includes an occluder, which is configured to selectively occlude at least 50% of a volume of the internal space of the filter cartridge,
wherein driving the liquid specimen sample into the filtration-chamber inlet comprises driving the liquid specimen sample into the filtration-chamber inlet while the oceluder is in a non-occluding configuration, in which the occluder does not occlude at least at least 50% of the volume of the internal space, and
wherein the method further comprises, after finishing driving the liquid specimen sample into the filtration-chamber inlet, transitioning the occluder from the non-occluding configuration to an occluding configuration, in which the occluder occludes at least 50% of the volume of the internal space.

109. The method according to claim 108, wherein transitioning the occluder from the non-occluding configuration to the occluding configuration comprises transitioning the occluder from the non-occluding configuration to the occluding configuration before entirely removing the filter assembly from the filtration chamber.

110. The method according to claim 108, wherein transitioning the occluder from the non-occluding configuration to the occluding configuration comprises transitioning the occluder from the non-occluding configuration to the occluding configuration after entirely removing the filter assembly from the filtration chamber.

111. The method according to claim 108, wherein transitioning the occluder from the non-occluding configuration to the occluding configuration comprises transitioning the occluder from the non-occluding configuration to the occluding configuration during removal of the filter assembly from the filtration chamber.

112. The method according to claim 108, wherein the occluder is configured to selectively occlude at least 80% of the volume of the internal space of the filter cartridge.

113. The method according to claim 112, wherein the occluder is configured to selectively occlude at least 90% of the volume of the internal space of the filter cartridge.

114. The method according to claim 108, wherein the occluder is configured to selectively occlude at least 50% of a volume of the internal space by selectively occupying at least 50% of the volume of the internal space.

115. The method according to claim 108, wherein the occluder is integrated into the filter assembly.

116. The method according to claim 115, wherein the handle is coupled to the occluder, and wherein transitioning the occluder from the non-occluding configuration to the occluding configuration comprises moving the handle with respect to the support shell.

117. The method according to claim 108, wherein the occluder includes a tubular shaft, which is configured to be disposable:
at least partially outside the internal space of the filter cartridge when in a non-occluding configuration, in which the tubular shaft does not occlude at least 50% of the volume of the internal space, and
at least partially within the internal space of the filter cartridge when in an occluding configuration, in which the tubular shaft occludes at least 50% of the volume of the internal space.

118. The method according to claim 117, wherein transitioning the occluder from the non-occluding configuration to the occluding configuration comprises sliding the tubular shaft with respect to the internal space of the filter cartridge.

119. The method according to claim 115,
wherein the occluder includes an occluder shell, which has proximal and distal ends, and an occluder-shell side wall that is shaped so as to define one or more occluder-shell side openings therethrough to an internal space defined by the occluder shell,
wherein the occluder shell is disposed within the support shell, and rotatable with respect to the support shell to set an alignment of the one or more occluder-shell side openings with the one or more support-shell side openings, and
wherein the occluder is configured to selectively assume:
the non-occluding configuration when the one or more occluder-shell side openings are aligned with the one or more support-shell side openings, and
the occluding configuration when the one or more occluder-shell side openings are not aligned with the one or more support-shell side openings.

120. The method according to claim 119, wherein the handle is coupled to the occluder shell, and wherein transitioning the occluder from the non-occluding configuration to the occluding configuration comprises rotating the handle with respect to the support shell so as to rotate the occluder shell with respect to the support shell.

121. The method according to claim 88,
wherein the filter unit is a first filter unit, the filtration chamber is a first filtration chamber, the filtration-chamber wall is a first filtration-chamber wall, the filtration-chamber inlet is a first filtration-chamber inlet, the filtration-chamber outlet is a first filtration-chamber outlet, the filter-assembly opening is a first filter-assembly opening, the filter assembly is a first filter assembly, the filter cartridge is a first filter cartridge, the support shell is a first support shell, the filter is a first filter, the handle is a first handle, and the fluid flow path is a first fluid flow path,
wherein driving the liquid specimen sample into the first filtration-chamber inlet drives the liquid specimen sample out of the first filtration-chamber outlet and into a second filtration-chamber inlet defined by a second filtration-chamber wall of a second filtration chamber of a second filter unit, the second filter unit further including a second filter assembly, which includes: (a) a second filter cartridge, which includes: (i) a second support shell, which has proximal and distal ends, and a second support-shell side wall that is shaped so as to define one or more support-shell side openings therethrough to an internal space defined by the second filter cartridge; and (ii) a second filter, which is coupled to the second support-shell side wall so as to cover the one or more support-shell side openings; and (b) a second handle, which is coupled to the proximal end of the second support shell,
wherein driving comprises driving the liquid specimen sample into the first filtration-chamber inlet while the second filter assembly is partially inserted into the second filtration chamber, such that (a) the second filter assembly passes through and forms a fluid-tight seal with a second filter-assembly opening defined by the second filtration-chamber wall, (b) the second handle is disposed outside the second filtration chamber, and (c) the second filter cartridge is disposed within the second filtration chamber such that the second filter unit defines: (i) a filtration-chamber space within the second filtration chamber between an inner surface of the second filtration-chamber wall and second the filter cartridge, and (ii) a second fluid flow path from the second filtration-chamber inlet to a second filtration-chamber outlet defined by the second filtration-chamber wall, the second fluid flow path providing fluid communication among the filtration-chamber space, the one or more support-shell side openings, and the second filter, wherein the second filter is configured to filter biological particulate from the liquid specimen sample when the liquid specimen sample is driven along the second fluid flow path while the second filter cartridge is disposed within the second filtration chamber; and
wherein the method further comprises, after finishing driving the liquid specimen sample into the first filtration-chamber inlet, entirely removing the second filter assembly from the second filtration chamber using the second handle.

122. The method according to claim 121, further comprising, after entirely removing the first and the second filter assemblies from the first and the second filtration chambers, respectively, testing for the presence of the biological particulate trapped by the first and the second filters.

123. The method according to claim 121,
wherein the first and the second filters are configured to filter first and second biological particulates from the liquid specimen sample, the first and the second biological particulates of different types, and
wherein the method further comprising, after entirely removing the first and the second filter assemblies from the first and the second filtration chambers, respectively, testing for the presence of the first and the second biological particulates trapped by the first and the second filters, respectively.

124. A method comprising:
filtering a liquid specimen sample using a filter assembly that includes (a) a filter cartridge, which includes: (i) a support shell, which has proximal and distal ends, and a support-shell side wall that is shaped so as to define one or more support-shell side openings therethrough to an internal space defined by the filter cartridge; and (ii) a filter, which is coupled to the support-shell side wall so as to cover the one or more support-shell side openings, and which is configured to filter biological particulate from the liquid specimen sample when the liquid specimen sample is driven through the filter and the one or more support-shell side openings; (b) a handle, which is coupled to the proximal end of the support shell; and (c) an occluder, which is configured to selectively occlude at least 50% of a volume of the internal space of the filter cartridge,
wherein filtering the liquid specimen comprises driving the liquid specimen sample through the filter and the one or more support-shell side openings while the occluder is in a non-occluding configuration, in which the occluder does not occlude at least at least 50% of the volume of the internal space; and
after filtering the liquid specimen sample, transitioning the occluder from the non-occluding configuration to an occluding configuration, in which the occluder occludes at least 50% of the volume of the internal space.

125. The method according to claim 124, wherein the occluder is configured to selectively occlude at least 80% of the volume of the internal space of the filter cartridge.

126. The method according to claim 125, wherein the occluder is configured to selectively occlude at least 90% of the volume of the internal space of the filter cartridge.

127. A liquid-specimen-sample processing system for processing a liquid specimen sample, the liquid-specimen-sample processing system comprising:
(a) a filter assembly, which comprises:
(i) a filter cartridge, which comprises:
(A) a support shell, which has proximal and distal ends, and a support-shell side wall that is shaped so as to define one or more support-shell side openings therethrough to an internal space defined by the filter cartridge; and
(B) a filter, which is coupled to an external surface of the support-shell side wall so as to cover the one or more support-shell side openings, and which is configured to filter biological particulate from the liquid specimen sample when the liquid specimen sample is driven through the filter and the one or more support-shell side openings;
(ii) a handle, which is coupled to the proximal end of the support shell; and
(b) a receptacle, wherein the filter assembly and the receptacle are configured such that the filter assembly is partially insertable into the receptacle using the handle, such that at least a portion of the handle is outside the receptacle and at least a portion of the filter cartridge is disposed within the receptacle, wherein an inner surface of a side wall of the receptacle is shaped so as to define one or more protrusions, which are configured to physically disturb the filter, when the filter assembly is as least partially within the receptacle, so as to help release, from the filter, the biological particulate trapped by the filter.

128. The liquid-specimen-sample processing system according to claim 127, wherein the one or more protrusions are configured to cut, tear, or macerate the filter.

129. The liquid-specimen-sample processing system according to claim 127, wherein the one or more protrusions are configured to scrape the filter.

130. The liquid-specimen-sample processing system according to claim 127, wherein the one or more protrusions are configured to agitate the filter.

131. The liquid-specimen-sample processing system according to any one of claims 127-130, wherein the receptacle contains a liquid medium, and wherein the one or more protrusions are configured to physically disturb the filter, while still allowing contact of the liquid medium with the filter, such that the released biological particulate is released into the liquid medium for subsequent testing.

132. The liquid-specimen-sample processing system according to any one of claims 127-130, wherein the one or more protrusions are configured to physically disturb the filter upon rotation of the filter assembly while within the receptacle.

133. The liquid-specimen-sample processing system according to any one of claims 127-130, wherein the one or more protrusions are configured to physically disturb the filter during insertion of the filter assembly into the receptacle.

134. The liquid-specimen-sample processing system according to any one of claims 127-130, wherein the one or more protrusions are shaped as one or more of the shapes selected from the group consisting of: one or more ridges, bristles, spikes, and bumps.

135. A method comprising
filtering a liquid specimen sample using a filter assembly that includes (a) a filter cartridge, which includes: (i) a support shell, which has proximal and distal ends, and a support-shell side wall that is shaped so as to define one or more support-shell side openings therethrough to an internal space defined by the filter cartridge; and (ii) a filter, which is coupled to an external surface of the support-shell side wall so as to cover the one or more support-shell side openings, and which is configured to filter biological particulate from the liquid specimen sample when the liquid specimen sample is driven through the filter and the one or more support-shell side openings; and (b) a handle, which is coupled to the proximal end of the support shell; and
after filtering the liquid specimen sample, partially inserting the filter assembly into a receptacle using the handle, such that at least a portion of the handle is outside the receptacle and at least a portion of the filter cartridge is disposed within the receptacle, wherein an inner surface of a side wall of the receptacle is shaped so as to define one or more protrusions, which are configured to physically disturb the filter, when the filter assembly is as least partially within the receptacle, so as to help release, from the filter, the biological particulate trapped by the filter.

136. The method according to claim 135, wherein inserting the filter assembly into the receptacle comprises inserting the filter assembly into the receptacle while the receptacle contains a liquid medium, and wherein the one or more protrusions are configured to physically disturb the filter, while still allowing contact of the liquid medium with the filter.

137. The method according to claim 135, wherein the one or more protrusions are configured to physically disturb the filter upon rotation of the filter assembly while within the receptacle, and wherein the method further comprises rotating the filter assembly while within the receptacle.

138. The method according to claim 135, wherein the one or more protrusions are configured to physically disturb the filter during insertion of the filter assembly into the receptacle, and wherein partially inserting the filter assembly into the receptacle comprises physically disturbing the filter while partially inserting the filter assembly into the receptacle.

139. The method according to claim 135, wherein the one or more protrusions are shaped as one or more of the shapes selected from the group consisting of: one or more ridges, bristles, spikes, and bumps.
